(19) United States
(12) Patent Application Publication
(10) Pub. No.: US 2026/0186382 A1
(43) Pub. Date: Jul. 2, 2026

(54) Camera Optical Lens

(71) Applicant: Changzhou AAC Raytech Optronics Co., Ltd., Changzhou City (CN)

(72) Inventor: Zhe Huang, Changzhou (CN)

(21) Appl. No.: 19/304,641

(22) Filed: Aug. 20, 2025

Related U.S. Application Data
(63) Continuation of application No. PCT/CN2024/144094, filed on Dec. 31, 2024.

(51) Int. Cl. G03B 17/17; G02B 9/60

(52) U.S. Cl. CPC G03B 17/17; G02B 9/60

(57) ABSTRACT

The present disclosure disclose a camera optical lens including a first prism, a first lens group with a first lens and a second lens, and a second lens group with a third lens, fourth lens, and fifth lens. The first lens group is movably adjustable. The design satisfies: 4.00≤fA/IH≤4.80; 0.10≤Rp1/Rp2≤1.00; and 0.20≤d5/d7≤1.20. By dividing the five-element lens into a first lens group and a second lens group, with the first lens group being movably adjusted for focus, an internal focusing mechanism is achieved; configuring the ratio of the focal length to the image height (fA/IH) in the first state enables a longer focal length under a fixed image height; designing a concave-convex configuration for the first prism mitigates the degree of light deflection through the lens elements; and strategically allocating the thicknesses of the third and fourth lenses contributes to compressing the total optical length.

### CROSS-REFERENCE TO RELATED APPLICATIONS

This application claims the priority benefit of PCT Patent Application Ser. No. PCT/CN2024/144094 filed on Dec. 31, 2024, the entire content of which is incorporated herein by reference.

### FIELD OF THE PRESENT DISCLOSURE

The present disclosure relates to optical technology, in particular to a camera optical lens.

### DESCRIPTION OF RELATED ART

With the rapid development and widespread adoption of smartphones, the research and design of camera lenses have advanced swiftly. Coupled with the current trend in electronic products toward high functionality and compact, slim form factors, miniaturized cameras with superior imaging quality have become the mainstream in the market. Among these, internal focusing camera lenses characterized by high stability, rapid zoom capability, superior dust resistance, and the ability to overcome wear issues inherent in external focusing systems have been progressively developed and applied in smartphone cameras.

Telephoto cameras can meet consumer demand for capturing specific subjects. Traditional telephoto cameras suffer from excessive total optical length, which conflicts with the slim design requirements of smartphones. In contrast, the periscope telephoto camera design significantly shortens the total optical length of camera optical lenses while fulfilling telephoto requirements. However, the optical performance of existing periscope telephoto camera lenses still falls short of meeting the requirements.

### SUMMARY

It is an object of the embodiments of the present disclosure to provide a camera optical lens capable of compressing the total optical length of the optical lens, satisfying movable focusing requirements, achieving a periscope-type design with a long focal length, and exhibiting excellent optical performance.

In order to overcome shortcomings in the prior art, the present disclosure provides a camera optical lens including, in an order from an object side to an image side in sequence: a first prism with a positive refractive power, a first lens with a negative refractive power, a second lens with a positive refractive power, a third lens with a negative refractive power, a fourth lens with a positive refractive power, and a fifth lens; wherein a reflective surface is disposed between the object side surface and the image side surface of the first prism, the first lens and the second lens are defined as a first lens group, while the third lens, the fourth lens and the fifth lens are defined as a second lens group, the first lens group is adjustably movable along the optical axis of the camera optical lens to switch the camera optical lens between a first state and a second state, the camera optical lens achieves its maximum focal length in the first state, and achieves its minimum focal length in the second state; and the camera optical lens further satisfies the following conditions:

$$4. \leq fA / IH \leq 4.8 ;$$

$$0. 10 \leq Rp 1 / Rp 2 \leq 1 \text{.00} ;$$

$$0.2 \leq d 5 / d 7 \leq 1 \text{.20} ;$$

where
fA: the focal length of the camera optical lens in the first state;
IH: the image height of the camera optical lens;
Rp1: the curvature radius of the object side surface of the first prism;
Rp2: the curvature radius of the image side surface of the first prism;
d5: the thickness on-axis of the third lens;
d7: the thickness on-axis of the fourth lens.

As an improvement, the camera optical lens further satisfies the following condition:

$$4. 10 \leq fA / IH \leq 4.70 .$$

As an improvement, an object side surface of the first prism is convex in the paraxial region, an image side surface of the first prism is concave in the paraxial region, and the camera optical lens further satisfies the following conditions:

$$1.24 \leq fp 1 / fA \leq 3.74 ;$$

$$0.37 \leq dp 1 / TTL \leq 0 \text{.39} ;$$

where
fp1: the focal length of the first prism;
dp1: the sum of the distance on-axis from the object side surface of the first prism to the reflective surface, and the distance on-axis from the reflective surface to the image side surface of the first prism;
TTL: the total optical length of the camera optical lens.

As an improvement, an image side surface of the first lens is concave in the paraxial region, and the camera optical lens further satisfies the following conditions:

$$- 1.77 \leq f 1 / fA \leq - 0 \text{.93} ;$$

$$0.2 \leq ( R 1 + R 2 ) / ( R 1 - R 2 ) \leq 5 \text{.82} ;$$

$$0.03 \leq d 1 / TTL \leq 0 \text{.06} ;$$

where
f1: the focal length of the first lens;
R1: the curvature radius of the object side surface of the first lens;
R2: the curvature radius of the image side surface of the first lens;
d1: the thickness on-axis of the first lens;
TTL: the total optical length of the camera optical lens.

As an improvement, an object side surface of the second lens is convex in the paraxial region, an image side surface of the second lens is convex in the paraxial region, and the camera optical lens further satisfies the following conditions:

$$0.36 \leq f 2 / fA \leq 0.4 ;$$

$$- 0. 7 \leq ( R 3 + R 4 ) / ( R 3 - R 4 ) \leq 0 \text{.04} ;$$

$$0.05 \leq d 3 / TTL \leq 0 \text{.11} ;$$

where
f2: the focal length of the second lens;
R3: the curvature radius of the object side surface of the second lens;
R4: the curvature radius of the image side surface of the second lens;
TTL: the total optical length of the camera optical lens.

As an improvement, the camera optical lens further satisfies the following condition:

$$0.30 \leq d 1 / d 3 \leq 1.00 ;$$

where
d1: the thickness on-axis of the first lens;
d3: the thickness on-axis of the second lens.

As an improvement, an object side surface of the third lens is concave in the paraxial region, and the camera optical lens further satisfies the following conditions:

$$- 0.72 \leq f 3 / fA \leq - 0.56 ;$$

$$- 1.2 \; 7 \leq ( R 5 + R 6 ) / ( R 5 - R 6 ) \leq - 0.7 ;$$

$$0.04 \leq d 5 / TTL \leq 0 \text{.15} ;$$

where
f3: the focal length of the third lens;
R5: the curvature radius of the object side surface of the third lens;
R6: the curvature radius of the image side surface of the third lens;
TTL: the total optical length of the camera optical lens.

As an improvement, an object side surface of the fourth lens is convex in the paraxial region, an image side surface of the fourth lens is convex in the paraxial region, and the camera optical lens further satisfies the following conditions:

$$1.13 \leq f 4 / fA \leq 1.63 ;$$

$$- 0.7 \; 0 \leq ( R 7 + R 8 ) / ( R 7 - R 8 ) \leq 0 \text{.74} ;$$

$$0.11 \leq d 7 / TTL \leq 0 \text{.16} ;$$

where
f4: the focal length of the fourth lens;
R7: the curvature radius of the object side surface of the fourth lens;
R8: the curvature radius of the image side surface of the fourth lens;
TTL: the total optical length of the camera optical lens.

As an improvement, the camera optical lens further satisfies the following conditions:

$$- 10.45 \leq f 5 / fA \leq 75.52 ;$$

$$- 19. 08 \leq ( R 9 + R 10 ) / ( R 9 - R 10 ) \leq 15 \text{.96} ;$$

$$d 9 / TTL \leq 0 \text{.03} ;$$

where
f5: the focal length of the fifth lens;
R9: the curvature radius of the object side surface of the fifth lens;
R10: the curvature radius of the image side surface of the fifth lens;
d9: the thickness on-axis of the fifth lens;
TTL: the total optical length of the camera optical lens.

As an improvement, the first prism is made of glass material.

The beneficial effects of the present disclosure are as follows. By dividing the five-element lens into a first lens group and a second lens group, with the first lens group being movably adjusted for focus, an internal focusing mechanism is achieved within the optical lens system; configuring the ratio of the focal length to the image height (fA/IH) in the first state enables a longer focal length under a fixed image height, thereby enhancing the optical magnification rate; designing a concave-convex configuration for the first prism mitigates the degree of light deflection through the lenses; and strategically allocating the thicknesses of the third and fourth lenses contributes to compressing the total optical length of the system.

### BRIEF DESCRIPTION OF THE DRAWINGS

One or more embodiments are exemplarily shown through the figures in the accompanying drawings which correspond thereto. These exemplary illustrations do not limit the embodiments. Elements denoted by the same reference numerals in the drawings represent similar elements. Where not otherwise stated, the figures in the drawings are not drawn to scale.

FIG. 1a is a schematic structural diagram of a camera optical lens in accordance with a first embodiment of the present disclosure in a first state;

FIG. 1b is a schematic structural diagram of a camera optical lens in accordance with a first embodiment of the present disclosure in a second state;

FIG. 2a, FIG. 3a and FIG. 4a respectively present a schematic diagram of the field curvature and distortion, the longitudinal aberration, and the lateral color of the camera optical lens shown in FIG. 1a;

FIG. 2b, FIG. 3b and FIG. 4b respectively present a schematic diagram of the field curvature and distortion, the longitudinal aberration, and the lateral color of the camera optical lens shown in FIG. 1b;

FIG. 5a is a schematic structural diagram of a camera optical lens in accordance with a second embodiment of the present disclosure in a first state;

FIG. 5b is a schematic structural diagram of a camera optical lens in accordance with a second embodiment of the present disclosure in a second state;

FIG. 6a, FIG. 7a and FIG. 8a respectively present a schematic diagram of the field curvature and distortion, the longitudinal aberration, and the lateral color of the camera optical lens shown in FIG. 5a;

FIG. 6b, FIG. 7b and FIG. 8b respectively present a schematic diagram of the field curvature and distortion, the longitudinal aberration, and the lateral color of the camera optical lens shown in FIG. 5b;

FIG. 9a is a schematic structural diagram of a camera optical lens in accordance with a third embodiment of the present disclosure in a first state;

FIG. 9b is a schematic structural diagram of a camera optical lens in accordance with a third embodiment of the present disclosure in a second state;

FIG. 10a, FIG. 11a and FIG. 12a respectively present a schematic diagram of the field curvature and distortion, the longitudinal aberration, and the lateral color of the camera optical lens shown in FIG. 9a;

FIG. 10b, FIG. 11b and FIG. 12b respectively present a schematic diagram of the field curvature and distortion, the longitudinal aberration, and the lateral color of the camera optical lens shown in FIG. 9b;

FIG. 13a is a schematic structural diagram of a camera optical lens in accordance with a fourth embodiment of the present disclosure in a first state;

FIG. 13b is a schematic structural diagram of a camera optical lens in accordance with a fourth embodiment of the present disclosure in a second state;

FIG. 14a, FIG. 15a and FIG. 16a respectively present a schematic diagram of the field curvature and distortion, the longitudinal aberration, and the lateral color of the camera optical lens shown in FIG. 13a;

FIG. 14b, FIG. 15b and FIG. 16b respectively present a schematic diagram of the field curvature and distortion, the longitudinal aberration, and the lateral color of the camera optical lens shown in FIG. 13b;

FIG. 17a is a schematic structural diagram of a camera optical lens in accordance with a fifth embodiment of the present disclosure in a first state;

FIG. 17b is a schematic structural diagram of a camera optical lens in accordance with a fifth embodiment of the present disclosure in a second state;

FIG. 18a, FIG. 19a and FIG. 20a respectively present a schematic diagram of the field curvature and distortion, the longitudinal aberration, and the lateral color of the camera optical lens shown in FIG. 17a;

FIG. 18b, FIG. 19b and FIG. 20b respectively present a schematic diagram of the field curvature and distortion, the longitudinal aberration, and the lateral color of the camera optical lens shown in FIG. 17b;

FIG. 21a is a schematic structural diagram of a camera optical lens in accordance with a sixth embodiment of the present disclosure in a first state;

FIG. 21b is a schematic structural diagram of a camera optical lens in accordance with a sixth embodiment of the present disclosure in a second state;

FIG. 22a, FIG. 23a and FIG. 24a respectively present a schematic diagram of the field curvature and distortion, the longitudinal aberration, and the lateral color of the camera optical lens shown in FIG. 21a;

FIG. 22b, FIG. 23b and FIG. 24b respectively present a schematic diagram of the field curvature and distortion, the longitudinal aberration, and the lateral color of the camera optical lens shown in FIG. 21b.

### DETAILED DESCRIPTION OF THE EXEMPLARY EMBODIMENTS

To make the objectives, technical solutions, and advantages of the embodiments of the present disclosure clearer, the embodiments of the present disclosure will be described in detail below with reference to the accompanying drawings. However, those of ordinary skill in the art may understand that in the embodiments of the present disclosure, numerous technical details are set forth to provide a better understanding of the invention. Nevertheless, the technical solutions claimed by the present disclosure may be implemented even without these technical details and various modifications based on the following embodiments.

In the embodiments of the present disclosure, terms such as “upper,” “lower,” “left,” “right,” “front,” “rear,” “top,” “bottom,” “inner,” “outer,” “central,” “vertical,” “horizontal,” “lateral,” and “longitudinal” indicate orientations or positional relationships based on the orientations or positional relationships shown in the accompanying drawings. These terms are primarily used to better describe the present disclosure and its embodiments, and are not intended to limit the indicated devices, elements, or components to having a specific orientation or being constructed and operated in a specific orientation.

Furthermore, some of the aforementioned terms may be used to indicate meanings other than orientation or positional relationships. For example, the term “upper” may in some cases also indicate a dependency or connection relationship. Those of ordinary skill in the art may understand the specific meanings of these terms in the present disclosure according to specific circumstances.

In addition, terms such as “install,” “arrange,” “provided with,” “open,” “connect,” and “connected” should be interpreted broadly. For example, connections may be fixed, detachable, or integrally formed; may be mechanical or electrical; may be direct connections, indirect connections through an intermediary, or internal communication between two devices, elements, or components. Those of ordinary skill in the art may understand the specific meanings of the above terms in the present disclosure according to specific circumstances.

Moreover, terms such as “first” and “second” are primarily used to distinguish different devices, elements, or components (which may be of the same or different types and structures), and are not intended to indicate the relative importance or quantity of the indicated devices, elements, or components. Unless otherwise specified, “a plurality” means two or more.

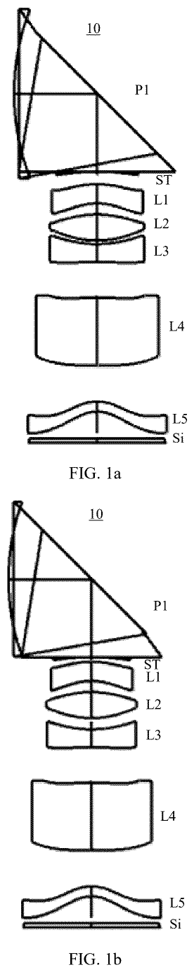

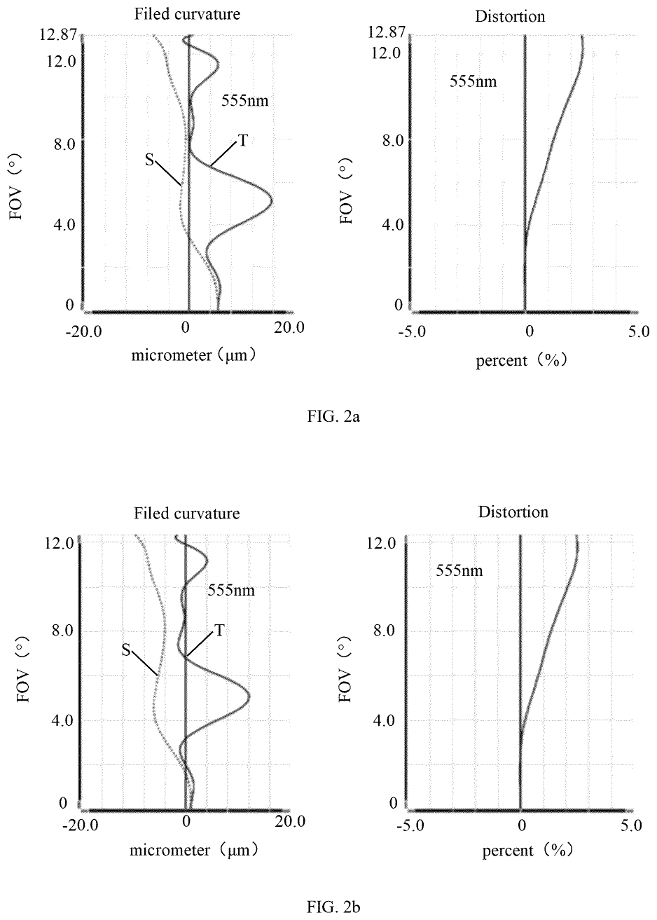

The technical solution of the present disclosure provides a camera optical lens 10, 20, 30, 40, 50, 60, as shown in FIGS. 1a, 1b, 5a, 5b, 9a, 9b, 13a, 13b, 17a, 17b, 21a, and 21b. The camera optical lens 10, 20, 30, 40, 50, 60 includes, sequentially arranged from the object side to the image side: a first prism P1 with positive refractive power, a first lens L1 with negative refractive power, a second lens L2 with positive refractive power, a third lens L3 with negative refractive power, a fourth lens L4 with positive refractive power, and a fifth lens L5. A reflective surface is provided between the object side surface and the image side surface of the first prism P1. The first lens L1 and the second lens L2 form a first lens group, and the third lens L3, the fourth lens L4, and the fifth lens L5 form a second lens group. The first lens group is movably adjustable along the optical axis of the camera optical lens 10, 20, 30, 40, 50, 60, enabling the camera optical lens 10, 20, 30, 40, 50, 60 to switch between a first state and a second state, wherein the camera optical lens 10, 20, 30, 40, 50, 60 has a maximum focal length in the first state and a minimum focal length in the second state.

The focal length of the camera optical lens 10, 20, 30, 40, 50, 60 in the first state is defined as fA, the image height of the camera optical lens 10, 20, 30, 40, 50, 60 in the first state is defined as IH, the curvature radius of the object side surface of the first prism P1 is defined as Rp1, the curvature radius of the image side surface of the first prism P1 is defined as Rp2, the thickness on-axis of the third lens L3 is defined as d5, and the thickness on-axis of the fourth lens L4 is defined as d7. The camera optical lens 10, 20, 30, 40, 50, 60 further satisfy following conditions:

$$4. \leq fA / IH \leq 4.8 ; \qquad ( 1 )$$

$$0.1 \leq Rp 1 / Rp 2 \leq 1 \text{.00} ; \qquad ( 2 )$$

$$0.2 \leq d 5 / d 7 \leq 1 \text{.20} . \qquad ( 3 )$$

The camera optical lens 10, 20, 30, 40, 50, 60 is a periscope optical lens with a five-element lens structure, which includes the first prism P1, first lens L1, second lens L2, third lens L3, fourth lens L4, and fifth lens L5 arranged in order from the object side to the image side.

The five-element lenses of the camera optical lens 10, 20, 30, 40, 50, 60 are the first lens L1, second lens L2, third lens L3, fourth lens L4, and fifth lens L5. These five lenses are divided into two groups (two lenses & three lenses): the first lens group and the second lens group. The first lens group is closer to the object side than the second lens group.

The first lens group is the front group, consisting of the first lens L1 and the second lens L2. The object side surface of the first lens group is the object side surface of the first lens L1, and the image side surface of the first lens group is the image side surface of the second lens L2. The second lens group is the rear group, consisting of the third lens L3, fourth lens L4, and fifth lens L5. The object side surface of the second lens group is the object side surface of the third lens L3, and the image side surface of the second lens group is the image side surface of the fifth lens L5.

The first lens group is positioned between the first prism P1 and the second lens group, and is movable along the optical axis of the camera optical lens 10, 20, 30, 40, 50, 60, thereby enabling adjustment of both the distance on-axis from the image side surface of the first prism P1 to the object side surface of the first lens group and the distance on-axis from the image side surface of the first lens group to the object side surface of the second lens group. Thus, the first lens group functions as a movable zoom group while the second lens group serves as a fixed focal length group, and through the displacement of the first lens group, the focal length of the camera optical lens 10, 20, 30, 40, 50, 60 can be varied, ensuring superior imaging performance in both a first state (where the focal length is maximized, e.g., a telephoto state or an infinity object-distance state) and a second state (where the focal length is minimized, e.g., a short-focus state, a macro state, or a 200 mm object-distance state), thereby achieving an internal focusing mechanism via movement of the front group.

Condition (1) defines the ratio range of the focal length fA in the first state to the image height IH for the camera optical lens 10, 20, 30, 40, 50, 60; within the limits specified by Condition (1), the lens maintains a longer focal length at a fixed image height IH, thereby enhancing its optical magnification. As an improvement, following condition is satisfied: 4.10≤IH/fA≤4.70.

Condition (2) defines the ratio range of the curvature radius Rp1 of the object side surface of the first prism P1 to the curvature radius Rp2 of the image side surface of the first prism P1, thereby controlling the convex/concave configuration of said surfaces. Within the range specified by Condition (2), the deflection of light passing through the first prism P1 is mitigated.

Condition (3) defines the ratio range of the thickness on-axis d5 of the third lens L3 to the thickness on-axis d7 of the fourth lens L4. Within the range specified by Condition (3), the axial thicknesses and air spacings of individual lenses are rationally allocated, thereby facilitating compression of the total optical length of the camera optical lens 10, 20, 30, 40, 50, 60.

The beneficial effects of the present invention lie in: by dividing the five-element lens into a first lens group and a second lens group, and enabling the first lens group to move for focusing, an internal focusing mechanism for the camera optical lens 10, 20, 30, 40, 50, 60 is achieved; setting the ratio of the focal length to the image height of the camera optical lens 10, 20, 30, 40, 50, 60 allows the lens to maintain a longer focal length at a fixed image height, thereby enhancing its magnification; configuring the convex/concave shape of the first prism P1 mitigates light deflection when passing through it; and rationally allocating the thicknesses of the third lens L3 and the fourth lens L4 facilitates compression of the total optical length of the camera optical lens 10, 20, 30, 40, 50, 60. Based on the aforementioned conditional expressions and achievable functions, the characteristics of each lens are further refined as follows.

As an improvement, the focal length of the first prism P1 is defined as fp1, the sum of the distance on-axis from the object side surface to the reflective surface and the distance on-axis from the reflective surface to the image side surface of the first prism P1 is defined as dp1, the total optical length of the camera optical lens 10, 20, 30, 40, 50, 60 is defined as TTL, and the following conditions are satisfied:

$$1.24 \leq fp 1 / fA \leq 3.74 ; \qquad ( 4 )$$

$$0.37 \leq dp 1 / TTL \leq 0 \text{.39} . \qquad ( 5 )$$

Condition (4) defines the ratio range of the focal length fp1 of the first prism P1 to the focal length fA in the first state for the camera optical lens 10, 20, 30, 40, 50, 60. Within the range specified by Condition (4), the optical performance of said lens is enhanced.

Condition (5) defines the ratio range of the sum of distances on-axis dp1 of the first prism P1 to the total optical length TTL of the camera optical lens 10, 20, 30, 40, 50, 60. Within the range specified by Condition (5), the total optical length TTL is effectively controlled, thereby facilitating a miniaturized design for the lens.

The object side surface of the first prism P1 is convex at the paraxial region, and the image side surface of the first prism P1 is concave at the paraxial region. The object side surface and image side surface of the first prism P1 may alternatively be configured with other concave/convex distributions.

As an improvement, the focal length of the first lens L1 is defined as f1, the curvature radius of the object side surface of the first lens L1 is defined as R1, the curvature radius of the image side surface of the first lens L1 is defined as R2, the thickness on-axis of the first lens L1 is defined as d1, and the following conditions are satisfied:

$$- 1.77 \leq f 1 / fA \leq - 0.93 \qquad ( 6 )$$

$$0.2 \leq ( R 1 + R 2 ) / ( R 1 - R 2 ) \leq 5.82 \qquad ( 7 )$$

$$0.03 \leq d 1 / TTL \leq 0.06 \qquad ( 8 )$$

Condition (6) defines the ratio range of the focal length f1 of the first lens L1 to the focal length fA in the first state for the camera optical lens 10, 20, 30, 40, 50, 60. Within the range specified by Condition (6), controlling the negative optical power of the first lens L1 within a rational scope facilitates correction of aberrations in the optical system.

Condition (7) defines the convex/concave configuration of the object side surface and image side surface of the first lens L1. Within the range specified by Condition (7), as the camera optical lens 10, 20, 30, 40, 50, 60 evolves toward miniaturization, it facilitates compensation of axial chromatic aberration.

Condition (8) defines the ratio range of the thickness on-axis d1 of the first lens L1 to the total optical length TTL of the camera optical lens 10, 20, 30, 40, 50, 60. Within the range specified by Condition (8), it facilitates control of the total optical length TTL, thereby achieving a miniaturized design for the camera optical lens 10, 20, 30, 40, 50, 60.

The object side surface of the first lens L1 is convex or concave at the paraxial region, and the image side surface of the first lens L1 is concave at the paraxial region. The image side surface may alternatively be configured as convex.

As an improvement, the focal length of the second lens L2 is defined as f2, the curvature radius of the object side surface of the second lens L2 is defined as R3, the curvature radius of the image side surface of the second lens L2 is defined as R4, the thickness on-axis of the second lens L2 is defined as d3, and the following conditions are satisfied:

$$0.36 \leq f 2 / fA \leq 0.4 ; \qquad ( 9 )$$

$$- 0.07 \leq ( R 3 + R 4 ) / ( R 3 - R 4 ) \leq 0.04 ; \qquad ( 10 )$$

$$0.05 \leq d 3 / TTL \leq 0 \text{.11} . \qquad ( 11 )$$

Condition (9) defines the ratio range of the focal length f2 of the second lens L2 to the focal length fA in the first state for the camera optical lens 10, 20, 30, 40, 50, 60. Within the range specified by Condition (9), rational allocation of refractive power enables the system to achieve enhanced imaging quality and reduced sensitivity.

Condition (10) defines the convex/concave configuration of the object side surface and image side surface of the second lens L2, which effectively controls the lens shape to facilitate the molding process; within the range specified by Condition (10), it mitigates light deflection through the lens and effectively reduces aberrations.

Condition (11) defines the ratio range of the thickness on-axis d3 of the second lens L2 to the total optical length TTL of the camera optical lens 10, 20, 30, 40, 50, 60. Within the range specified by Condition (11), it facilitates control of the total optical length TTL, thereby achieving a miniaturized design for the camera optical lens 10, 20, 30, 40, 50, 60.

The object side surface of the second lens L2 is convex at the paraxial region, and the image side surface of the second lens L2 is convex at the paraxial region. The object side surface and image side surface may alternatively be configured with other concave/convex distributions.

As an improvement, the camera optical lens 10, 20, 30, 40, 50, 60 satisfies the following conditions:

$$0.3 \leq d 1 / d 3 \leq 1. . \qquad ( 12 )$$

Condition (12) defines the ratio range of the thickness on-axis d1 of the first lens L1 to the thickness on-axis d3 of the second lens L2. Within the range specified by Condition (12), it facilitates rational allocation of the thicknesses on-axis and air intervals among the lenses, thereby reducing assembly difficulty and improving the yield rate of the camera optical lenses 10, 20, 30, 40, 50, 60 during actual production.

As an improvement, the focal length of the third lens L3 is defined as f3, the central curvature radius of the object side surface of the third lens L3 is defined as R5, the central curvature radius of the image side surface of the third lens L3 is defined as R6, and the following conditions are satisfied:

$$- 0.7 \; 2 \leq f 3 / fA \leq - 0 \text{.56} ; \qquad ( 13 )$$

$$- 1.27 \leq ( R 5 + R 6 ) / ( R 5 - R 6 ) \leq - 0.71 ; \qquad ( 14 )$$

$$0.04 \leq d 5 / TTL \leq 0 \text{.15} . \qquad ( 15 )$$

Condition (13) defines the ratio range of the focal length f3 of the third lens L3 to the focal length fA in the first state for the camera optical lens 10, 20, 30, 40, 50, 60. Within the range specified by Condition (13), it contributes to reducing aberrations and enhancing the imaging quality of the lens.

Condition (14) defines the convex/concave configuration of the object side surface and image side surface of the third lens L3. Within the range specified by Condition (14), as the camera optical lens evolves toward miniaturization, it facilitates compensation for axial chromatic aberration.

Condition (15) defines the ratio range of the thickness on-axis d5 of the third lens L3 to the total optical length TTL of the camera optical lens 10, 20, 30, 40, 50, 60. Within the range specified by Condition (15), it facilitates control of the total optical length TTL, thereby achieving a miniaturized design.

The object side surface of the third lens L3 is concave at the paraxial region, and the image side surface of the third lens L3 is concave or convex at the paraxial region. The object side surface may alternatively be configured as convex.

As an improvement, the focal length of the fourth lens L4 is defined as f4, the curvature radius of the object side surface of the fourth lens L4 is defined as R7, the curvature radius of the image side surface of the fourth lens L4 is defined as R8, and the following conditions are satisfied:

$$1.13 \leq f 4 / fA \leq 1.63 ; \qquad ( 16 )$$

$$- 0.7 \leq ( R 7 + R 8 ) / ( R 7 - R 8 ) \leq 0.74 ; \qquad ( 17 )$$

$$0.11 \leq d 7 / TTL \leq 0 \text{.16} . \qquad ( 18 )$$

Condition (16) defines the ratio range of the focal length f4 of the fourth lens L4 to the focal length fA in the first state for the camera optical lens 10, 20, 30, 40, 50, 60. Within the range specified by Condition (16), it effectively achieves gentle light ray angles and reduces tolerance sensitivity for the lens.

Condition (17) defines the convex/concave configuration of the object side surface and image side surface of the fourth lens L4. Within the range specified by Condition (17), it rationally controls the shape of the fourth lens L4, enabling effective correction of spherical aberration in the system.

Condition (18) defines the ratio range of the thickness on-axis d7 of the fourth lens L4 to the total optical length TTL of the camera optical lens 10, 20, 30, 40, 50, 60. Within the range specified by Condition (18), it facilitates control of the total optical length TTL, thereby achieving a miniaturized design.

The object side surface of the fourth lens L4 is convex at the paraxial region, and the image side surface of the fourth lens L4 is convex at the paraxial region. The object side surface and image side surface may alternatively be configured with other concave/convex distributions.

As an improvement, the focal length of the fifth lens L5 is defined as f5, the curvature radius of the object side surface of the fifth lens L5 is defined as R9, the curvature radius of the image side surface of the fifth lens L5 is defined as R10, the thickness on-axis of the fifth lens L5 is defined as d9, and the following conditions are satisfied:

$$- 10. 45 \leq f 5 / fA \leq 75 \text{.52} ; \qquad ( 19 )$$

$$- 19. 08 \leq ( R 9 + R 10 ) / ( R 9 - R 10 ) \leq 15.96 ; \qquad ( 20 )$$

$$d 9 / TTL \leq 0 \text{.03} ; \qquad ( 21 )$$

Condition (19) defines the ratio range of the focal length f5 of the fifth lens L5 to the focal length fA in the first state for the camera optical lens 10, 20, 30, 40, 50, 60. Within the range specified by Condition (19), rational allocation of optical power enables the system to achieve enhanced imaging quality and reduced sensitivity.

Condition (20) defines the convex/concave configuration of the object side surface and image side surface of the fifth lens L5. Within the range specified by Condition (20), as the camera optical lens evolves toward miniaturization, it facilitates compensation for axial chromatic aberration.

Condition (21) defines the ratio range of the thickness on-axis d9 of the fifth lens L5 to the total optical length TTL of the camera optical lens 10, 20, 30, 40, 50, 60. Within the range specified by Condition (21), it facilitates control of the total optical length TTL, thereby achieving a miniaturized design.

The fifth lens L5 has positive or negative refractive power. The object side surface of the fifth lens L5 is convex or concave at the paraxial region, and the image side surface of the fifth lens L5 is convex or concave at the paraxial region.

In the present disclosure, the material of the first prism P1 is glass, and the materials of the first lens L1, second lens L2, third lens L3, fourth lens L4, and fifth lens L5 are plastic. Alternatively, the first prism P1 and the lenses may be configured with other materials.

An optical filter GF is disposed between the fifth lens L5 and the image plane Si, wherein the optical filter GF may be a glass cover plate or an optical filter. Alternatively, the optical filter GF may be disposed at other positions.

An aperture stop ST may further be disposed between the first prism P1 and the first lens L1.

The following embodiments illustrate the camera optical lenses 10, 20, 30, 40, 50, 60 of the present disclosure. The symbols used in each embodiment are listed in Table [1], with units of focal length, distance on-axis, curvature radius, and thickness on-axis being millimeters (mm).

TTL: Total optical length (the distance on-axis from the object side surface of the first prism P1 to the image plane SI), expressed in millimeters.

### Embodiment 1

The first prism P1 has a positive refractive power, with its object side surface convex in the paraxial region and its image side surface concave in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface convex in the paraxial region;

The third lens L3 has a negative refractive power, with its object side surface concave in the paraxial region and its image side surface concave in the paraxial region;

The fourth lens L4 has a positive refractive power, with its object side surface convex in the paraxial region and its image side surface convex in the paraxial region;

The fifth lens L5 has a negative refractive power, with its object side surface convex in the paraxial region and its image side surface concave in the paraxial region.

FIGS. 1a and 1b are schematic structural diagrams of the camera optical lens 10 in the first embodiment. The design data of the camera optical lens 10 in the first embodiment are shown below.

Table 1 lists the curvature radius R of the object side and image side surfaces from the first prism P1 to the fifth lens L5 constituting the camera optical lens 10 in the first embodiment of the present disclosure, the thickness on-axis of each lens, the distance on-axis d between adjacent lenses, the refractive index nd, and the Abbe number vd. Note that in this implementation, the units for distance, radius, and thickness are all millimeters (mm).

TABLE 1

| | R | d | | nd | | vd | |
|---|---|---|---|---|---|---|---|
| ST | ∞ | d0= | −9.719 | | | | |
| Rp1 | 14.040 | dp1= | 9.500 | nd1 | 1.8052 | vd1 | 40.89 |
| Rp2 | 14.040 | dp2= | dp2 | | | | |
| R1 | 5.114 | d1= | 1.140 | nd2 | 1.6400 | vd2 | 23.54 |
| R2 | 3.613 | d2= | 0.651 | | | | |
| R3 | 5.840 | d3= | 1.532 | nd3 | 1.5444 | vd3 | 55.82 |
| R4 | −5.781 | d4= | d4 | | | | |
| R5 | −6.099 | d5= | 1.068 | nd4 | 1.6153 | vd4 | 25.94 |
| R6 | 46.237 | d6= | 2.087 | | | | |
| R7 | 19.724 | d7= | 4.000 | nd5 | 1.6700 | vd5 | 19.39 |
| R8 | −110.397 | d8= | 2.126 | | | | |
| R9 | 2.204 | d9= | 0.600 | nd6 | 1.5346 | vd6 | 55.69 |
| R10 | 1.944 | d10= | 1.602 | | | | |
| R11 | ∞ | d11= | 0.210 | ndg | 1.5168 | vdg | 64.17 |
| R12 | ∞ | d12= | 0.030 | | | | |

In which, d1=“dp1-01”+“dp1-02”, “dp1-01”=4.9, and “dp1-02”=4.6.

Table 2 shows data of related optical parameters for the camera optical lens 10 according to the first embodiment of the present disclosure in a first state and a second state, respectively.

TABLE 2

| | First state | Second state |
|---|---|---|
| f | 15.378 | 14.400 |
| FOV | 25.74° | 23.24° |
| FNO | 2.30 | 2.53 |
| dp2 | 0.739 | 0.279 |
| d4 | 0.215 | 0.675 |

In which, the meaning of the various symbols is as follows.
R: The curvature radius of the optical surface, the central curvature radius in case of lens;
S1: Aperture;
Rp1: The curvature radius of the object side surface of the first prism P1;
Rp2: The curvature radius of the image side surface of the first prism P1;
R1: The curvature radius of the object side surface of the first lens L1;
R2: The curvature radius of the image side surface of the first lens L1;
R3: The curvature radius of the object side surface of the second lens L2;
R4: The curvature radius of the image side surface of the second lens L2;
R5: The curvature radius of the object side surface of the third lens L3;
R6: The curvature radius of the image side surface of the third lens L3;
R7: The curvature radius of the object side surface of the fourth lens L4;
R8: The curvature radius of the image side surface of the fourth lens L4;
R9: The curvature radius of the object side surface of the fifth lens L5;
R10: The curvature radius of the image side surface of the fifth lens L5;
R11: The curvature radius of the object side surface of the optical filter GF;
R12: The curvature radius of the image side surface of the optical filter GF;
d: The thickness on-axis of the lens and the distance on-axis between the lens;
do: The distance on-axis from aperture S1 to the object side surface of the first prism P1;
dp1: The sum of the distance on-axis from the object side surface of the first prism P1 to the reflective surface, and the distance on-axis from the reflective surface to the image side surface of the first prism P1;
dp1-01: The distance on-axis from the object side surface of the first prism P1 to the reflective surface;
dp1-02: The distance on-axis from the reflective surface to the image side surface of the first prism P1;
dp2: The distance on-axis from the image side surface of the first prism P1 to the object side surface of the first lens L1;
d1: The thickness on-axis of the first lens L1;
d2: The distance on-axis from the image side surface of the first lens L1 to the object side surface of the second lens L2;
d3: The thickness on-axis of the second lens L2;
d4: The distance on-axis from the image side surface of the second lens L2 to the object side surface of the third lens L3;
d5: The thickness on-axis of the third lens L3;
d6: The distance on-axis from the image side surface of the third lens L3 to the object side surface of the fourth lens L4;
d7: The thickness on-axis of the fourth lens L4;
d8: The distance on-axis from the image side surface of the fourth lens L4 to the object side surface of the fifth lens L5;
d9: The thickness on-axis of the fifth lens L5;
d10: The distance on-axis from the image side surface of the fifth lens L5 to the object side surface of the optical filter GF;
d11: The thickness on-axis of the optical filter GF;
d12: The distance on-axis from the image side surface of the optical filter GF to the image plane SI;
nd: The refractive power of the d line;
nd1: The refractive power of the d line of the first prism P1;
nd2: The refractive power of the d line of the first lens L1;
nd3: The refractive power of the d line of the second lens L2;
nd4: The refractive power of the d line of the third lens L3;
nd5: The refractive power of the d line of the fourth lens L4;
nd6: The refractive power of the d line of the fifth lens L5;
ndg: The refractive power of the d line of the optical filter GF;
vd: The abbe number;
vd1: The abbe number of the first prism P1;
vd2: The abbe number of the first lens L1;
vd3: The abbe number of the second lens L2;
vd4: The abbe number of the third lens L3;
vd5: The abbe number of the fourth lens L4;
Vd6: The abbe number of the fifth lens L5;
vdg: The abbe number of the optical filter GF.

Table 3 shows the conic index and aspherical surface index of the camera optical lens 10 according to the first embodiment of the present disclosure.

TABLE 3

| | Conic | | | |
|---|---|---|---|---|
| | Index | Aspherical Surface Index | | |
| | K | A4 | A6 | A8 |
| Rp1 | −1.85174E+00 | 1.46210E−04 | 2.97500E−06 | −6.49680E−07 |
| Rp2 | 0.00000E+00 | 0.00000E+00 | 0.00000E+00 | 0.00000E+00 |
| R1 | −4.10086E+00 | −9.17810E−04 | −5.53330E−04 | 4.31360E−05 |
| R2 | −7.44785E−01 | −4.88060E−03 | −8.43430E−04 | 2.41600E−04 |
| R3 | −1.23547E+01 | 6.04660E−03 | −1.51380E−03 | 2.95640E−04 |
| R4 | 3.81177E−02 | 3.22770E−04 | −1.22950E−04 | 6.47120E−05 |
| R5 | −2.42282E+01 | −9.24710E−03 | 3.39450E−03 | −1.06830E−03 |
| R6 | −6.00566E+00 | −3.14070E−04 | 6.26970E−05 | −6.76130E−04 |
| R7 | −1.49081E+01 | −3.73190E−03 | −2.99610E−04 | 5.87460E−04 |
| R8 | 0.00000E+00 | −6.36430E−03 | 2.25800E−03 | −1.24080E−03 |
| R9 | −1.03520E+00 | −3.04890E−02 | 1.57690E−02 | −8.39860E−03 |
| R10 | −1.91372E+00 | −2.43320E−02 | 2.50620E−02 | −1.57760E−02 |

| | Aspherical Surface Index | | | |
|---|---|---|---|---|
| | A10 | A12 | A14 | A16 |
| Rp1 | 9.45480E−08 | −8.44880E−09 | 4.77240E−10 | −1.66690E−11 |
| Rp2 | 0.00000E+00 | 0.00000E+00 | 0.00000E+00 | 0.00000E+00 |
| R1 | 8.04570E−06 | −1.46340E−05 | 6.83600E−06 | −1.72570E−06 |
| R2 | −1.05410E−04 | 3.21900E−05 | −6.75550E−06 | 1.14430E−06 |
| R3 | −4.11290E−05 | −5.10700E−06 | 4.18790E−06 | −8.53050E−07 |
| R4 | −3.06300E−05 | 1.01540E−05 | −1.77260E−06 | 1.79990E−07 |
| R5 | 2.25840E−04 | −2.36160E−05 | −1.05080E−06 | 6.03580E−07 |
| R6 | 9.67930E−04 | −8.21750E−04 | 4.44070E−04 | −1.60860E−04 |
| R7 | −6.06530E−04 | 3.79860E−04 | −1.61980E−04 | 4.87590E−05 |
| R8 | 5.03970E−04 | −1.43170E−04 | 2.85340E−05 | −4.01000E−06 |
| R9 | 2.72140E−03 | −5.94960E−04 | 9.44620E−05 | −1.13880E−05 |
| R10 | 5.89570E−03 | −1.48590E−03 | 2.68330E−04 | −3.56460E−05 |

| | Conic | | | | | | |
|---|---|---|---|---|---|---|---|
| | Index | Aspherical Surface Index | | | | | |
| | K | A18 | A20 | A22 | A24 | A26 | A28 |
| Rp1 | −1.85174E+00 | 3.30150E−13 | −2.84500E−15 | 0.00E+00 | 0.00E+00 | 0.00E+00 | 0.00E+00 |
| Rp2 | 0.00000E+00 | 0.00000E+00 | 0.00000E+00 | 0.00E+00 | 0.00E+00 | 0.00E+00 | 0.00E+00 |
| R1 | −4.10086E+00 | 2.55770E−07 | −2.11950E−08 | 7.64E−10 | 0.00E+00 | 0.00E+00 | 0.00E+00 |
| R2 | −7.44785E−01 | −1.64100E−07 | 1.55320E−08 | −6.40E−10 | 0.00E+00 | 0.00E+00 | 0.00E+00 |
| R3 | −1.23547E+01 | 7.65710E−08 | −2.58250E−09 | 0.00E+00 | 0.00E+00 | 0.00E+00 | 0.00E+00 |
| R4 | 3.81177E−02 | −1.11350E−08 | 3.70780E−10 | 0.00E+00 | 0.00E+00 | 0.00E+00 | 0.00E+00 |
| R5 | −2.42282E+01 | −6.39430E−08 | 2.32960E−09 | 0.00E+00 | 0.00E+00 | 0.00E+00 | 0.00E+00 |
| R6 | −6.00566E+00 | 4.00840E−05 | −6.90500E−06 | 8.09E−07 | −6.16E−08 | 2.75E−09 | −5.48E−11 |
| R7 | −1.49081E+01 | −1.04970E−05 | 1.60890E−06 | −1.72E−07 | 1.21E−08 | −5.08E−10 | 9.61E−12 |
| R8 | 0.00000E+00 | 3.95050E−07 | −2.66780E−08 | 1.18E−09 | −3.05E−11 | 3.56E−13 | −1.16E−16 |
| R9 | −1.03520E+00 | 1.06700E−06 | −7.75490E−08 | 4.23E−09 | −1.61E−10 | 3.77E−12 | −4.05E−14 |
| R10 | −1.91372E+00 | 3.50470E−06 | −2.52460E−07 | 1.30E−08 | −4.48E−10 | 9.32E−12 | −8.83E−14 |

Note that in this embodiment, the aspheric surfaces of each lens are defined by Formula (22) below; however, the specific form of Formula (22) is exemplary only, and the aspheric polynomial form represented by Formula (22) is not limited in practice.

$$z = ( c {r}^{2} ) / \{ 1 + [ 1 - {( k + 1 ) ( {c}^{2} {r}^{2} ) ]}^{1 / 2} \} + A 4 {r}^{4} + A 6 {r}^{6} + A8 {r}^{8} + A 10 {r}^{10} + A 12 {r}^{12} + A 14 {r}^{14} + A 16 {r}^{16} + A 18 \qquad ( 22 )$$

$${r}^{18} + A 20 {r}^{20} + A 22 {r}^{22} + A 24 {r}^{24} + A 26 {r}^{26} + A 28 {r}^{28}$$

Among them, K is a conic index, A4, A6, A8, A10, A12, A14, A16, A18, A20, A22, A24, A26, A28 are aspheric surface indexes, c is the curvature at the center of the optical surface, r is the vertical distance from the optical axis to a point on the aspheric curve, and z is the sagitta (i.e., the vertical distance between a point on the aspheric surface at distance r from the optical axis and a plane tangent to the vertex of the aspheric surface on the optical axis).

Additionally, in the subsequent Table 19, the values corresponding to various parameters defined in the conditional expressions for the first embodiment are listed.

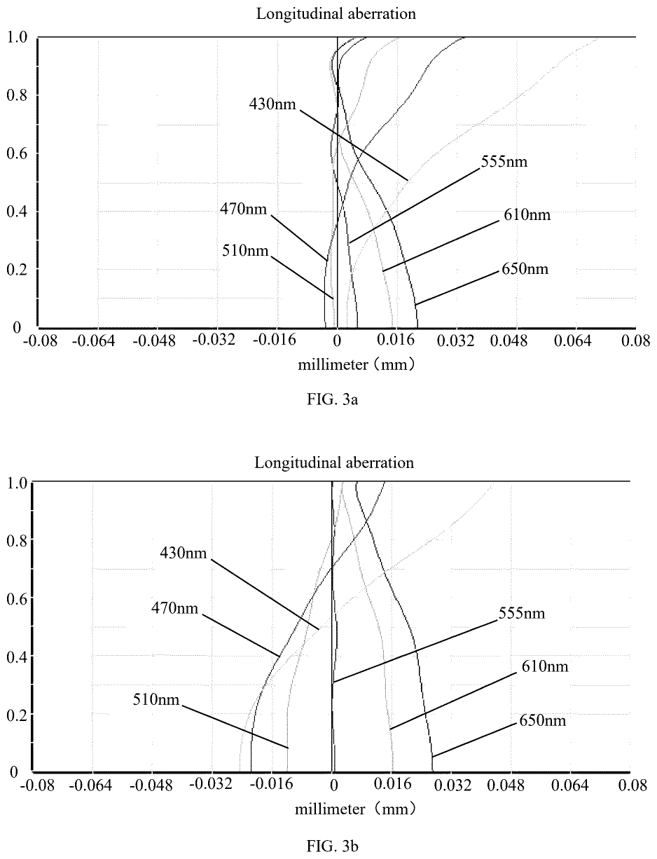

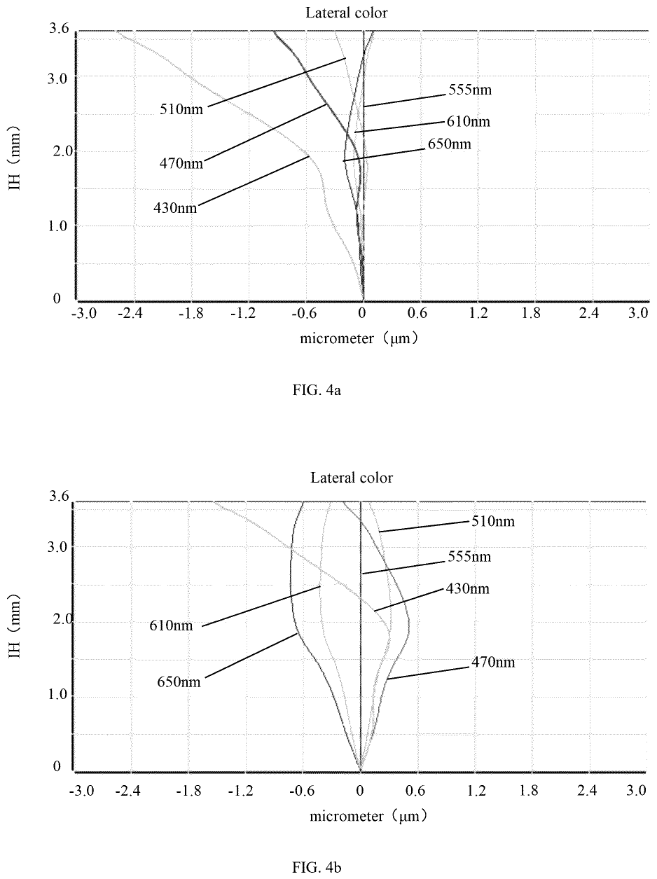

FIG. 2a and FIG. 2b show the field curvature and distortion schematic diagrams after light with a wavelength of 555 nm passes the camera optical lens 10 of the first embodiment. FIG. 3a and FIG. 3b show the longitudinal aberration schematic diagrams after light with a wavelength of 430 nm, 470 nm, 510 nm, 555 nm, 610 nm and 650 nm passes the camera optical lens 10 of the first embodiment. FIG. 4a and FIG. 4b show the lateral color schematic diagrams after light with a wavelength of 430 nm, 470 nm, 510 nm, 555 nm, 610 nm and 650 nm passes the camera optical lens 10 of the first embodiment.

As shown in Table 19, the first embodiment satisfies all conditional expressions.

In this embodiment, the entrance pupil diameter (ENPD) of the camera optical lens 10 in the first state is 6.69 mm, the full field image height (IH) is 3.600 mm, and the diagonal field of view (FOV) is 25.74°. The camera optical lens 10 satisfies the characteristics of large aperture, telephoto capability, and miniaturization, with both on-axis and off-axis chromatic aberrations fully corrected, while exhibiting excellent optical performance.

### Embodiment 2

The first prism P1 has a positive refractive power, with its object side surface convex in the paraxial region and its image side surface concave in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface convex in the paraxial region;

The third lens L3 has a negative refractive power, with its object side surface concave in the paraxial region and its image side surface concave in the paraxial region;

The fourth lens L4 has a positive refractive power, with its object side surface convex in the paraxial region and its image side surface convex in the paraxial region;

The fifth lens L5 has a negative refractive power, with its object side surface convex in the paraxial region and its image side surface concave in the paraxial region.

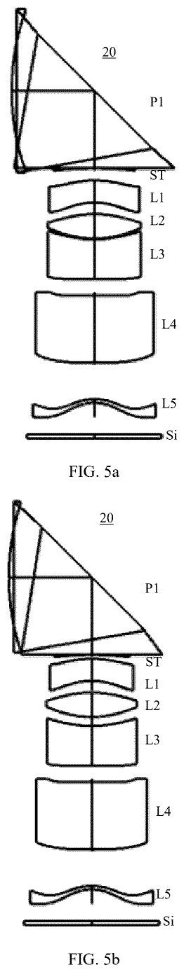

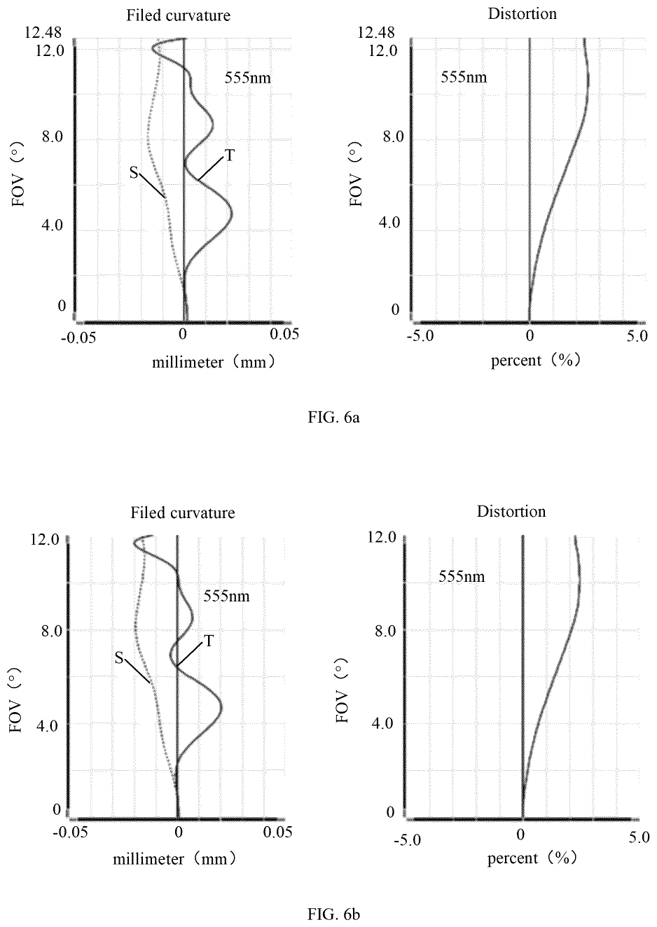

FIGS. 5a and 5b are schematic structural diagrams of the camera optical lens 20 in the second embodiment. The symbol meanings in the second embodiment are the same as those in the first embodiment.

Tables 4˜6 show the design data of the camera optical lens 20 in the second embodiment.

TABLE 4

| | R | d | | nd | | vd | |
|---|---|---|---|---|---|---|---|
| ST | ∞ | d0= | −9.671 | | | | |
| Rp1 | 14.358 | dp1= | 9.500 | nd1 | 1.8052 | vd1 | 40.89 |
| Rp2 | 20.486 | dp2= | dp2 | | | | |
| R1 | 5.593 | dl= | 1.304 | nd2 | 1.6400 | vd2 | 23.54 |
| R2 | 3.695 | d2= | 0.693 | | | | |
| R3 | 6.295 | d3= | 1.443 | nd3 | 1.5444 | vd3 | 55.82 |
| R4 | −5.981 | d4= | d4 | | | | |
| R5 | −6.066 | d5= | 2.338 | nd4 | 1.6153 | vd4 | 25.94 |
| R6 | 273.855 | d6= | 0.967 | | | | |
| R7 | 26.984 | d7= | 4.000 | nd5 | 1.6700 | vd5 | 19.39 |
| R8 | −32.173 | d8= | 2.144 | | | | |
| R9 | 2.477 | d9= | 0.211 | nd6 | 1.5346 | vd6 | 55.69 |
| R10 | 2.123 | d10= | 1.890 | | | | |
| R11 | ∞ | d11= | 0.210 | ndg | 1.5168 | vdg | 64.17 |
| R12 | ∞ | d12= | 0.030 | | | | |

In which, d1=“dp1-01”+“dp1-02”, “dp1-01”=4.9, and “dp1-02”=4.6.

Table 5 shows data of related optical parameters for the camera optical lens 20 according to the second embodiment of the present disclosure in a first state and a second state, respectively.

TABLE 5

| | First state | Second state |
|---|---|---|
| f | 15.889 | 14.671 |
| FOV | 24.96° | 21.69° |
| FNO | 2.31 | 2.58 |
| dp2 | 0.716 | 0.231 |
| d4 | 0.054 | 0.539 |

Table 6 shows the conic index and aspherical surface index of the camera optical lens 20.

TABLE 6

| | Conic | | | | | | | |
|---|---|---|---|---|---|---|---|---|
| | Index | Aspherical Surface Index | | | | | | |
| | K | A4 | A6 | A8 | A10 | A12 | A14 | A16 |
| Rp1 | −1.99323E+00 | 1.40300E−04 | −7.97140E−07 | 6.06850E−07 | −1.29570E−07 | 1.52610E−08 | −1.05740E−09 | 4.30080E−11 |
| Rp2 | 0.00000E+00 | 0.00000E+00 | 0.00000E+00 | 0.00000E+00 | 0.00000E+00 | 0.00000E+00 | 0.00000E+00 | 0.00000E+00 |
| R1 | −3.98382E+00 | −1.37340E−03 | −2.30800E−04 | −1.51380E−04 | 9.96820E−05 | −4.22860E−05 | 1.23180E−05 | −2.44010E−06 |
| R2 | −6.91122E−01 | −4.50730E−03 | −5.32100E−04 | −8.95820E−05 | 4.15600E−05 | −4.10800E−06 | −2.41910E−06 | 1.19300E−06 |
| R3 | −1.30797E+01 | 5.26770E−03 | −1.05220E−03 | 8.48200E−05 | 9.61510E−06 | −8.73040E−06 | 2.84670E−06 | −4.63740E−07 |
| R4 | −3.04002E−02 | 2.03570E−04 | 4.88320E−05 | −5.95800E−05 | 2.95330E−05 | −7.73540E−06 | 1.47670E−06 | −1.80830E−07 |
| R5 | −2.60393E+01 | −9.79570E−03 | 4.13470E−03 | −1.54870E−03 | 4.60280E−04 | −9.88180E−05 | 1.42810E−05 | −1.29820E−06 |
| R6 | −8.37720E−04 | 2.43460E−03 | −3.47710E−03 | 3.30660E−03 | −2.32600E−03 | 1.05410E−03 | −3.05590E−04 | 5.23100E−05 |
| R7 | −6.67905E+01 | −4.55210E−04 | −5.55980E−03 | 7.36220E−03 | −6.89540E−03 | 4.38220E−03 | −1.95050E−03 | 6.17880E−04 |
| R8 | 4.47983E+01 | −1.48150E−03 | 7.54980E−04 | −7.15540E−04 | 3.66410E−04 | −1.37510E−04 | 4.00550E−05 | −9.12200E−06 |
| R9 | −9.23868E−01 | −4.76730E−02 | 3.89600E−02 | −2.54770E−02 | 1.04570E−02 | −2.98370E−03 | 6.23160E−04 | −9.76840E−05 |
| R10 | −2.36966E+00 | −3.00480E−02 | 3.97570E−02 | −2.78680E−02 | 1.16820E−02 | −3.33690E−03 | 6.85950E−04 | −1.03850E−04 |

| | Conic | | | | | | |
|---|---|---|---|---|---|---|---|
| | Index | Aspherical Surface Index | | | | | |
| | K | A18 | A20 | A22 | A24 | A26 | A28 |
| Rp1 | −1.99323E+00 | −9.50400E−13 | 8.81050E−15 | 0.00E+00 | 0.00E+00 | 0.00E+00 | 0.00E+00 |
| Rp2 | 0.00000E+00 | 0.00000E+00 | 0.00000E+00 | 0.00E+00 | 0.00E+00 | 0.00E+00 | 0.00E+00 |
| R1 | −3.98382E+00 | 3.15320E−07 | −2.39780E−08 | 8.10E−10 | 0.00E+00 | 0.00E+00 | 0.00E+00 |
| R2 | −6.91122E−01 | −2.40280E−07 | 2.34570E−08 | −9.07E−10 | 0.00E+00 | 0.00E+00 | 0.00E+00 |
| R3 | −1.30797E+01 | 3.72830E−08 | −1.17420E−09 | 0.00E+00 | 0.00E+00 | 0.00E+00 | 0.00E+00 |
| R4 | −3.04002E−02 | 1.25170E−08 | −3.55720E−10 | 0.00E+00 | 0.00E+00 | 0.00E+00 | 0.00E+00 |
| R5 | −2.60393E+01 | 6.67440E−08 | −1.48430E−09 | 0.00E+00 | 0.00E+00 | 0.00E+00 | 0.00E+00 |
| R6 | −8.37720E−04 | −3.18550E−06 | −6.91670E−07 | 1.94E−07 | −2.17E−08 | 1.23E−09 | −2.91E−11 |
| R7 | −6.67905E+01 | −1.39940E−04 | 2.24780E−05 | −2.50E−06 | 1.83E−07 | −7.91E−09 | 1.53E−10 |
| R8 | 4.47983E+01 | 1.59120E−06 | −2.05140E−07 | 1.87E−08 | −1.13E−09 | 4.01E−11 | −6.37E−13 |
| R9 | −9.23868E−01 | 1.15830E−05 | −1.02940E−06 | 6.66E−08 | −2.95E−09 | 7.98E−11 | −9.88E−13 |
| R10 | −2.36966E+00 | 1.16370E−05 | −9.55020E−07 | 5.58E−08 | −2.20E−09 | 5.21E−11 | −5.61E−13 |

Additionally, in the subsequent Table 19, the values corresponding to various parameters defined in the conditional expressions for the second embodiment are listed.

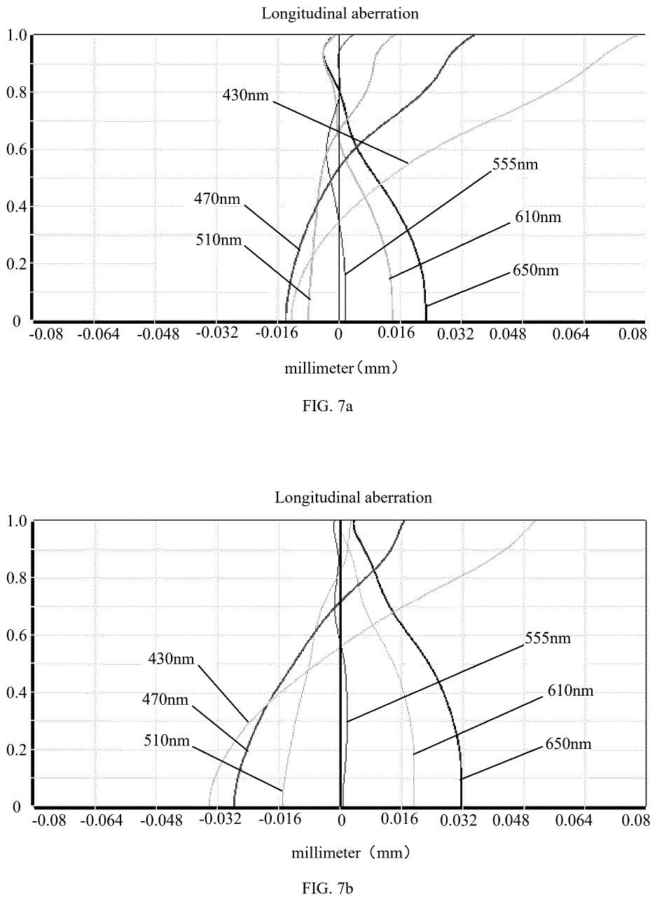

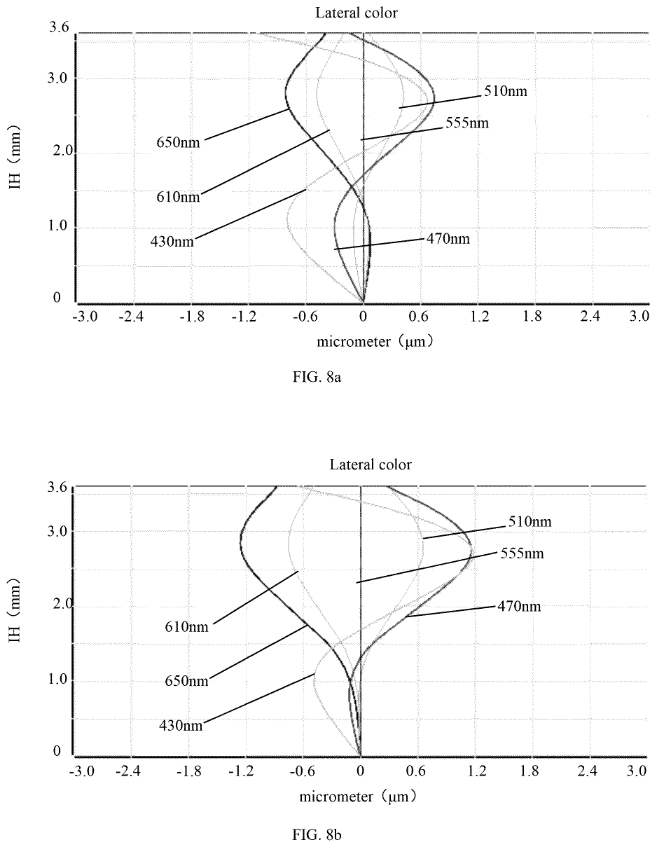

FIG. 6a and FIG. 6b show the field curvature and distortion schematic diagrams after light with a wavelength of 555 nm passes the camera optical lens 20 of the second embodiment. FIG. 7a and FIG. 7b show the longitudinal aberration schematic diagrams after light with a wavelength of 430 nm, 470 nm, 510 nm, 555 nm, 610 nm and 650 nm passes the camera optical lens 20 of the second embodiment. FIG. 8a and FIG. 8b show the lateral color schematic diagrams after light with a wavelength of 430 nm, 470 nm, 510 nm, 555 nm, 610 nm and 650 nm passes the camera optical lens 20 of the second embodiment.

As shown in Table 19, the second embodiment satisfies all conditional expressions.

In this embodiment, the entrance pupil diameter (ENPD) of the camera optical lens 20 in the first state is 6.877 mm, the full field image height (IH) is 3.600 mm, and the diagonal field of view (FOV) is 24.96°. The camera optical lens 20 satisfies the characteristics of large aperture, telephoto capability, and miniaturization, with both on-axis and off-axis chromatic aberrations fully corrected, while exhibiting excellent optical performance.

### Embodiment 3

The first prism P1 has a positive refractive power, with its object side surface convex in the paraxial region and its image side surface concave in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface convex in the paraxial region;

The third lens L3 has a negative refractive power, with its object side surface concave in the paraxial region and its image side surface convex in the paraxial region;

The fourth lens L4 has a positive refractive power, with its object side surface convex in the paraxial region and its image side surface convex in the paraxial region;

The fifth lens L5 has a negative refractive power, with its object side surface convex in the paraxial region and its image side surface concave in the paraxial region.

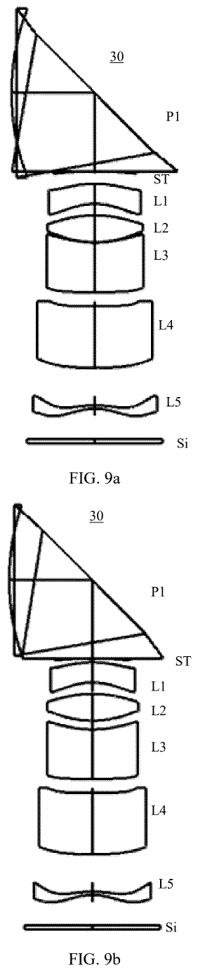

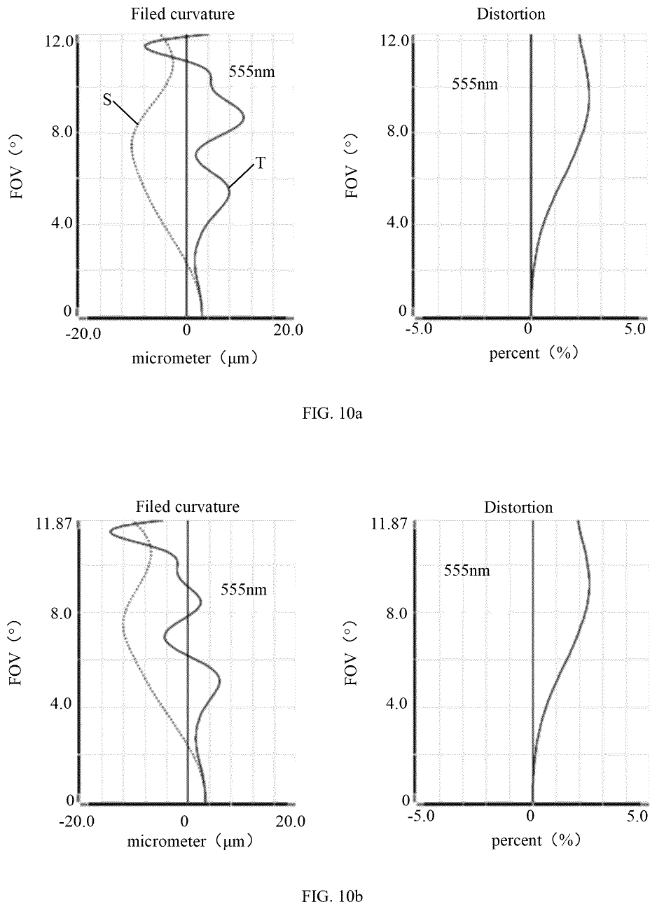

FIGS. 9a and 9b are schematic structural diagrams of the camera optical lens 30 in the third embodiment. The symbol meanings in the third embodiment are the same as those in the first embodiment.

Tables 7˜9 show the design data of the camera optical lens 30 in the third embodiment.

TABLE 7

| | R | d | | nd | | vd | |
|---|---|---|---|---|---|---|---|
| ST | ∞ | d0= | −9.676 | | | | |
| Rp1 | 14.180 | dp1= | 9.500 | nd1 | 1.8052 | vd1 | 40.89 |
| Rp2 | 20.257 | dp2= | dp2 | | | | |
| R1 | 5.554 | d1= | 1.188 | nd2 | 1.6400 | vd2 | 23.54 |
| R2 | 3.706 | d2= | 0.671 | | | | |
| R3 | 6.413 | d3= | 1.580 | nd3 | 1.5444 | vd3 | 55.82 |
| R4 | −6.014 | d4= | d4 | | | | |
| R5 | −6.165 | d5= | 2.912 | nd4 | 1.6153 | vd4 | 25.94 |
| R6 | −53.275 | d6= | 0.800 | | | | |
| R7 | 106.449 | d7= | 3.657 | nd5 | 1.6700 | vd5 | 19.39 |
| R8 | −16.305 | d8= | 2.193 | | | | |
| R9 | 5.165 | d9= | 0.202 | nd6 | 1.5346 | vd6 | 55.69 |
| R10 | 3.099 | d10= | 1.799 | | | | |
| R11 | ∞ | d11= | 0.210 | ndg | 1.5168 | vdg | 64.17 |
| R12 | ∞ | d12= | 0.030 | | | | |

In which, d1=“dp1-01”+“dp1-02”, “dp1-01”=4.9, and “dp1-02”=4.6.

Table 8 shows data of related optical parameters for the camera optical lens 30 according to the third embodiment of the present disclosure in a first state and a second state, respectively.

TABLE 8

| | First state | Second state |
|---|---|---|
| f | 16.218 | 14.627 |
| FOV | 22.10° | 23.74° |
| FNO | 2.31 | 2.64 |
| dp2 | 0.730 | 0.236 |
| d4 | 0.027 | 0.521 |

Table 9 shows the conic index and aspherical surface index of the camera optical lens 30.

TABLE 9

| | Conic | | | | | | | |
|---|---|---|---|---|---|---|---|---|
| | Index | Aspherical Surface Index | | | | | | |
| | K | A4 | A6 | A8 | A10 | A12 | A14 | A16 |
| Rp1 | −1.94276E+00 | 1.43760E−04 | 3.44340E−07 | 8.04740E−08 | −2.03530E−08 | 2.57510E−09 | −1.81020E−10 | 7.27790E−12 |
| Rp2 | 0.00000E+00 | 0.00000E+00 | 0.00000E+00 | 0.00000E+00 | 0.00000E+00 | 0.00000E+00 | 0.00000E+00 | 0.00000E+00 |
| R1 | −4.04063E+00 | −1.57910E−03 | −1.96240E−04 | −1.58370E−04 | 1.17110E−04 | −5.61340E−05 | 1.78010E−05 | −3.69260E−06 |
| R2 | −6.48423E−01 | −5.21110E−03 | −2.03630E−04 | −1.28430E−04 | 5.17000E−05 | −1.35860E−05 | 1.88130E−06 | 1.57540E−07 |
| R3 | −1.30104E+01 | 4.33050E−03 | −6.11470E−04 | −4.90860E−05 | 6.40370E−05 | −2.77330E−05 | 7.04650E−06 | −1.00520E−06 |
| R4 | 9.17596E−02 | −2.14100E−04 | 3.93320E−04 | −2.75660E−04 | 1.26690E−04 | −3.71600E−05 | 7.12680E−06 | −8.38480E−07 |
| R5 | −2.53026E+01 | −9.50150E−03 | 3.72720E−03 | −1.37450E−03 | 4.10470E−04 | −8.86870E−05 | 1.28960E−05 | −1.18230E−06 |
| R6 | 0.00000E+00 | 2.21750E−03 | −1.77890E−03 | 8.56440E−04 | −4.22370E−04 | 8.26130E−05 | 3.39200E−05 | −2.91350E−05 |
| R7 | −1.44073E+01 | −4.23550E−04 | −2.43610E−03 | 2.28580E−03 | −2.17750E−03 | 1.43190E−03 | −6.63560E−04 | 2.20050E−04 |
| R8 | 1.49992E+01 | 1.01400E−03 | 2.24270E−04 | −4.19430E−04 | 1.53530E−04 | −2.83700E−05 | 1.16650E−06 | 7.54200E−07 |
| R9 | −3.60642E−01 | −4.94560E−02 | 4.61080E−02 | −3.10260E−02 | 1.28430E−02 | −3.57740E−03 | 6.97270E−04 | −9.64380E−05 |
| R10 | −5.69866E+00 | −3.24970E−02 | 4.52810E−02 | −3.25090E−02 | 1.40670E−02 | −4.16050E−03 | 8.86380E−04 | −1.39150E−04 |

| | Conic | | | | | | |
|---|---|---|---|---|---|---|---|
| | Index | Aspherical Surface Index | | | | | |
| | K | A18 | A20 | A22 | A24 | A26 | A28 |
| Rp1 | −1.94276E+00 | −1.56250E−13 | 1.38490E−15 | 0.00E+00 | 0.00E+00 | 0.00E+00 | 0.00E+00 |
| Rp2 | 0.00000E+00 | 0.00000E+00 | 0.00000E+00 | 0.00E+00 | 0.00E+00 | 0.00E+00 | 0.00E+00 |
| R1 | −4.04063E+00 | 4.84010E−07 | −3.64830E−08 | 1.20E−09 | 0.00E+00 | 0.00E+00 | 0.00E+00 |
| R2 | −6.48423E−01 | −9.68540E−08 | 1.24470E−08 | −5.40E−10 | 0.00E+00 | 0.00E+00 | 0.00E+00 |
| R3 | −1.30104E+01 | 7.45590E−08 | −2.23220E−09 | 0.00E+00 | 0.00E+00 | 0.00E+00 | 0.00E+00 |
| R4 | 9.17596E−02 | 5.47220E−08 | −1.49960E−09 | 0.00E+00 | 0.00E+00 | 0.00E+00 | 0.00E+00 |
| R5 | −2.53026E+01 | 6.14120E−08 | −1.37800E−09 | 0.00E+00 | 0.00E+00 | 0.00E+00 | 0.00E+00 |
| R6 | 0.00000E+00 | 9.87760E−06 | −1.98580E−06 | 2.53E−07 | −2.02E−08 | 9.21E−10 | −1.84E−11 |
| R7 | −1.44073E+01 | −5.23860E−05 | 8.86800E−06 | −1.04E−06 | 8.03E−08 | −3.67E−09 | 7.52E−11 |
| R8 | 1.49992E+01 | −2.09730E−07 | 2.84630E−08 | −2.31E−09 | 1.13E−10 | −2.99E−12 | 3.23E−14 |
| R9 | −3.60642E−01 | 9.45850E−06 | −6.49350E−07 | 3.04E−08 | −9.33E−10 | 1.74E−11 | −1.61E−13 |
| R10 | −5.69866E+00 | 1.61730E−05 | −1.37700E−06 | 8.35E−08 | −3.41E−09 | 8.39E−11 | −9.39E−13 |

Additionally, in the subsequent Table 19, the values corresponding to various parameters defined in the conditional expressions for the third embodiment are listed.

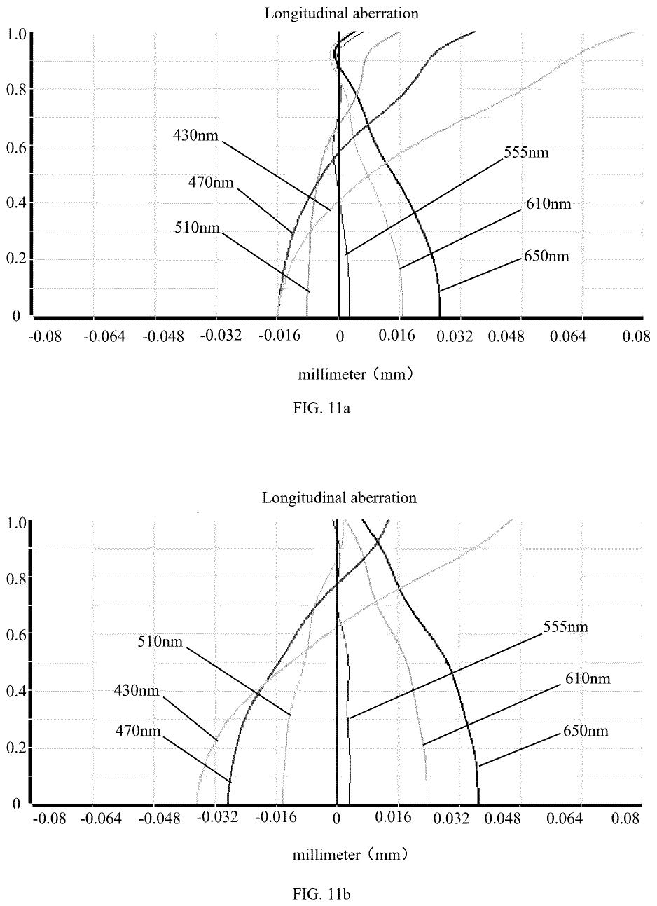

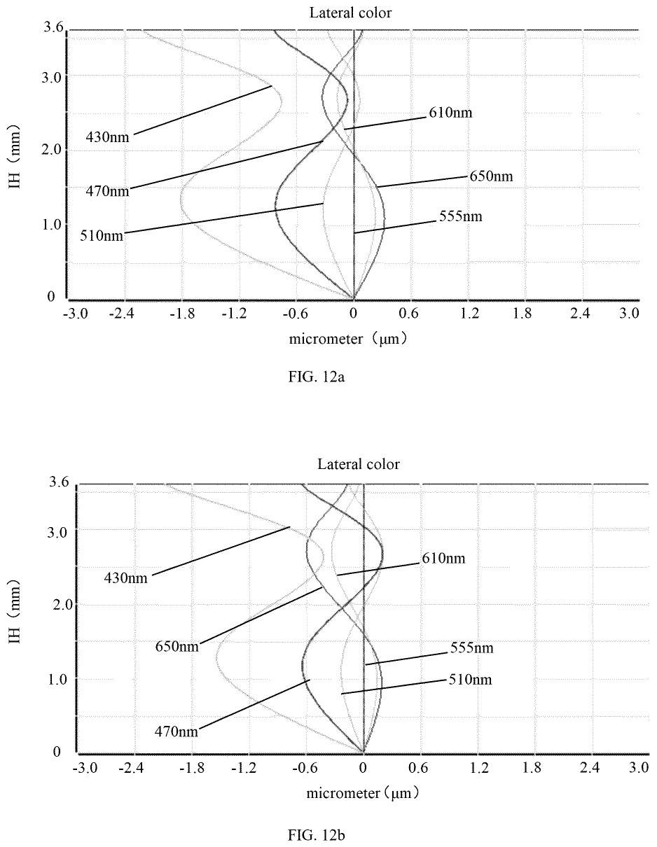

FIG. 10a and FIG. 10b show the field curvature and distortion schematic diagrams after light with a wavelength of 555 nm passes the camera optical lens 30 of the third embodiment. FIG. 11a and FIG. 11b show the longitudinal aberration schematic diagrams after light with a wavelength of 430 nm, 470 nm, 510 nm, 555 nm, 610 nm and 650 nm passes the camera optical lens 30 of the third embodiment. FIG. 12a and FIG. 12b show the lateral color schematic diagrams after light with a wavelength of 430 nm, 470 nm, 510 nm, 555 nm, 610 nm and 650 nm passes the camera optical lens 30 of the third embodiment.

As shown in Table 19, the third embodiment satisfies all conditional expressions.

In this embodiment, the entrance pupil diameter (ENPD) of the camera optical lens 30 in the first state is 6.33 mm, the full field image height (IH) is 3.600 mm, and the diagonal field of view (FOV) is 22.10°. The camera optical lens 30 satisfies the characteristics of large aperture, telephoto capability, and miniaturization, with both on-axis and off-axis chromatic aberrations fully corrected, while exhibiting excellent optical performance.

### Embodiment 4

The first prism P1 has a positive refractive power, with its object side surface convex in the paraxial region and its image side surface concave in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface convex in the paraxial region;

The third lens L3 has a negative refractive power, with its object side surface concave in the paraxial region and its image side surface concave in the paraxial region;

The fourth lens L4 has a positive refractive power, with its object side surface convex in the paraxial region and its image side surface convex in the paraxial region;

The fifth lens L5 has a negative refractive power, with its object side surface concave in the paraxial region and its image side surface convex in the paraxial region.

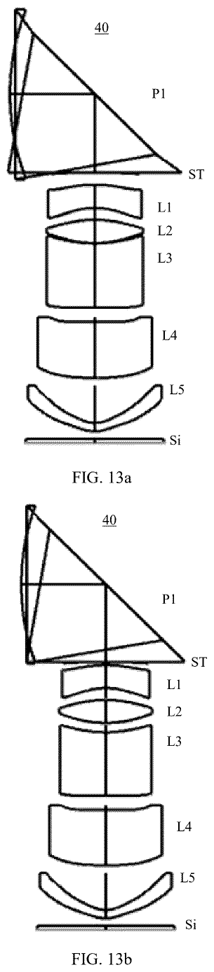

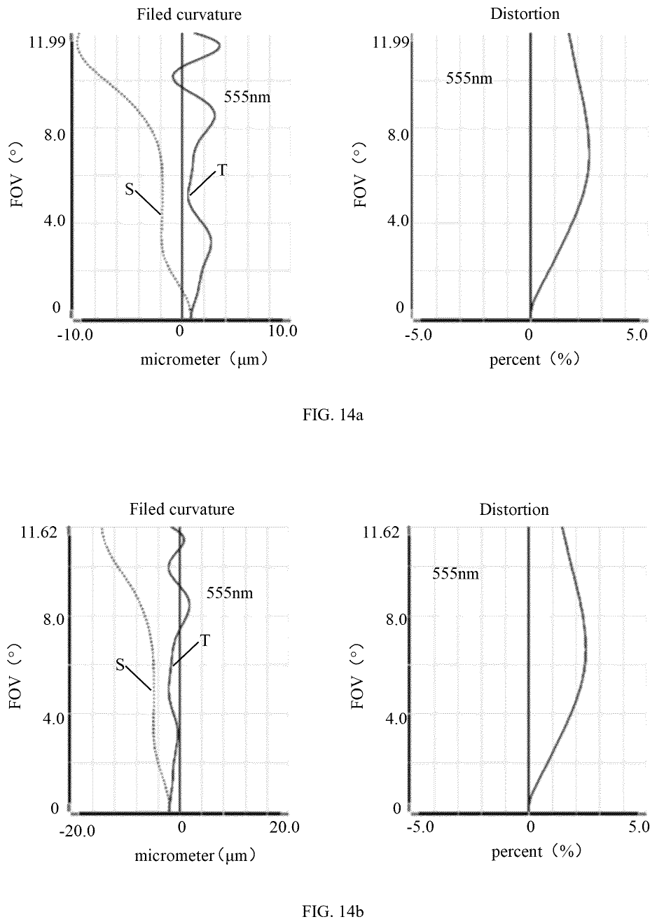

FIGS. 13a and 13b are schematic structural diagrams of the camera optical lens 40 in the fourth embodiment. The symbol meanings in the fourth embodiment are the same as those in the first embodiment.

Tables 10˜12 show the design data of the camera optical lens 40 in the fourth embodiment.

TABLE 10

| | R | d | | nd | | vd | |
|---|---|---|---|---|---|---|---|
| ST | ∞ | d0= | −9.617 | | | | |
| Rp1 | 14.245 | dp1= | 9.500 | nd1 | 1.8052 | vd1 | 40.89 |
| Rp2 | 37.046 | dp2= | dp2 | | | | |
| R1 | 6.404 | d1= | 1.365 | nd2 | 1.6400 | vd2 | 23.54 |
| R2 | 3.776 | d2= | 0.700 | | | | |
| R3 | 6.190 | d3= | 1.365 | nd3 | 1.5444 | vd3 | 55.82 |
| R4 | −6.509 | d4= | d4 | | | | |
| R5 | −6.646 | d5= | 3.743 | nd4 | 1.6153 | vd4 | 25.94 |
| R6 | 85.063 | d6= | 0.856 | | | | |
| R7 | 48.569 | d7= | 3.297 | nd5 | 1.6700 | vd5 | 19.39 |
| R8 | −17.609 | d8= | 2.646 | | | | |
| R9 | −1.536 | d9= | 0.500 | nd6 | 1.5346 | vd6 | 55.69 |
| R10 | −1.706 | d10= | 0.451 | | | | |
| R11 | ∞ | d11= | 0.210 | ndg | 1.5168 | vdg | 64.17 |
| R12 | ∞ | d12= | 0.030 | | | | |

In which, d1=“dp1-01”+“dp1-02”, “dp1-01”=4.9, and “dp1-02”=4.6.

Table 11 shows data of related optical parameters for the camera optical lens 40 according to the fourth embodiment of the present disclosure in a first state and a second state, respectively.

TABLE 11

| | First state | Second state |
|---|---|---|
| f | 16.686 | 16.028 |
| FOV | 23.97° | 23.32° |
| FNO | 2.32 | 2.47 |
| dp2 | 0.717 | 0.189 |
| d4 | 0.03 | 0.558 |

Table 12 shows the conic index and aspherical surface index of the camera optical lens 40.

TABLE 12

| | Conic | | | | | | | |
|---|---|---|---|---|---|---|---|---|
| | Index | Aspherical Surface Index | | | | | | |
| | K | A4 | A6 | A8 | A10 | A12 | A14 | A16 |
| Rp1 | −1.96867E+00 | 1.45940E−04 | 1.76340E−07 | −2.65610E−08 | 9.56520E−09 | −1.25030E−09 | 9.29430E−11 | −3.99960E−12 |
| Rp2 | 0.00000E+00 | 0.00000E+00 | 0.00000E+00 | 0.00000E+00 | 0.00000E+00 | 0.00000E+00 | 0.00000E+00 | 0.00000E+00 |
| R1 | −4.07568E+00 | −2.43510E−03 | −1.71070E−04 | −8.59050E−06 | 1.51260E−05 | −9.31700E−06 | 3.39410E−06 | −7.65670E−07 |
| R2 | −6.52304E−01 | −6.27330E−03 | −3.12110E−04 | 1.32520E−04 | −8.63080E−05 | 3.91640E−05 | −1.16240E−05 | 2.27030E−06 |
| R3 | −1.33648E+01 | 4.79330E−03 | −1.15910E−03 | 2.35170E−04 | −6.23370E−05 | 1.61360E−05 | −3.13680E−06 | 4.24840E−07 |
| R4 | 1.62958E−01 | 1.96700E−04 | −1.63050E−04 | 1.21270E−04 | −5.97200E−05 | 1.99940E−05 | −4.20350E−06 | 5.48530E−07 |
| R5 | −2.69190E+01 | −8.25240E−03 | 2.77570E−03 | −8.34770E−04 | 2.09220E−04 | −3.95200E−05 | 5.19820E−06 | −4.42290E−07 |
| R6 | 0.00000E+00 | 9.01880E−05 | −1.26300E−03 | 1.11860E−03 | −8.95220E−04 | 4.83700E−04 | −1.80610E−04 | 4.72370E−05 |
| R7 | −8.93197E+01 | −3.17490E−03 | −1.64960E−03 | 1.76540E−03 | −1.68970E−03 | 1.10310E−03 | −5.07740E−04 | 1.67160E−04 |
| R8 | 2.17943E+01 | −9.69800E−04 | −7.18710E−04 | 5.22560E−04 | −3.10980E−04 | 1.21750E−04 | −3.17530E−05 | 5.62250E−06 |
| R9 | −4.21746E+00 | −4.02770E−02 | 4.11590E−02 | −2.28640E−02 | 7.67180E−03 | −1.70220E−03 | 2.57870E−04 | −2.67510E−05 |
| R10 | −6.31925E+00 | −2.55770E−02 | 3.45200E−02 | −1.80960E−02 | 5.46530E−03 | −1.09050E−03 | 1.51460E−04 | −1.49580E−05 |

| | Conic | | | | | | |
|---|---|---|---|---|---|---|---|
| | Index | Aspherical Surface Index | | | | | |
| | K | A18 | A20 | A22 | A24 | A26 | A28 |
| Rp1 | −1.96867E+00 | −3.2468E−04 | 3.4438E−05 | 0.0000E+00 | 0.0000E+00 | 0.0000E+00 | 0.0000E+00 |
| Rp2 | 0.00000E+00 | 7.7822E−01 | −1.3598E−01 | 0.0000E+00 | 0.0000E+00 | 0.0000E+00 | 0.0000E+00 |
| R1 | −4.07568E+00 | −4.3087E+00 | 8.1287E−01 | 0.0000E+00 | 0.0000E+00 | 0.0000E+00 | 0.0000E+00 |
| R2 | −6.52304E−01 | −2.0330E+06 | 9.2617E+06 | −2.8875E+07 | 6.0262E+07 | −8.0254E+07 | 6.1457E+07 |
| R3 | −1.33648E+01 | 1.6848E+07 | −8.9564E+07 | 3.3519E+08 | −8.6111E+08 | 1.4434E+09 | −1.4204E+09 |
| R4 | 1.62958E−01 | −1.9937E+06 | 5.3658E+06 | −1.0380E+07 | 1.4050E+07 | −1.2621E+07 | 6.7560E+06 |
| R5 | −2.69190E+01 | 2.6187E+05 | −5.3022E+05 | 7.7372E+05 | −7.9249E+05 | 5.4055E+05 | −2.2046E+05 |
| R6 | 0.00000E+00 | 7.1170E+03 | −7.6818E+03 | 5.9762E+03 | −3.2613E+03 | 1.1840E+03 | −2.5673E+02 |
| R7 | −8.93197E+01 | 3.8134E+03 | −3.8287E+03 | 2.7758E+03 | −1.4132E+03 | 4.7905E+02 | −9.7051E+01 |
| R8 | 2.17943E+01 | 2.7994E+01 | −1.9897E+01 | 1.0310E+01 | −3.7552E+00 | 9.0680E−01 | −1.3002E−01 |
| R9 | −4.21746E+00 | 4.7279E−01 | −1.5324E−01 | 3.5389E−02 | −5.6918E−03 | 6.0616E−04 | −3.8425E−05 |
| R10 | −6.31925E+00 | −6.2406E−03 | 1.0548E−03 | −1.2922E−04 | 1.1258E−05 | −6.6808E−07 | 2.4497E−08 |

Additionally, in the subsequent Table 19, the values corresponding to various parameters defined in the conditional expressions for the fourth embodiment are listed.

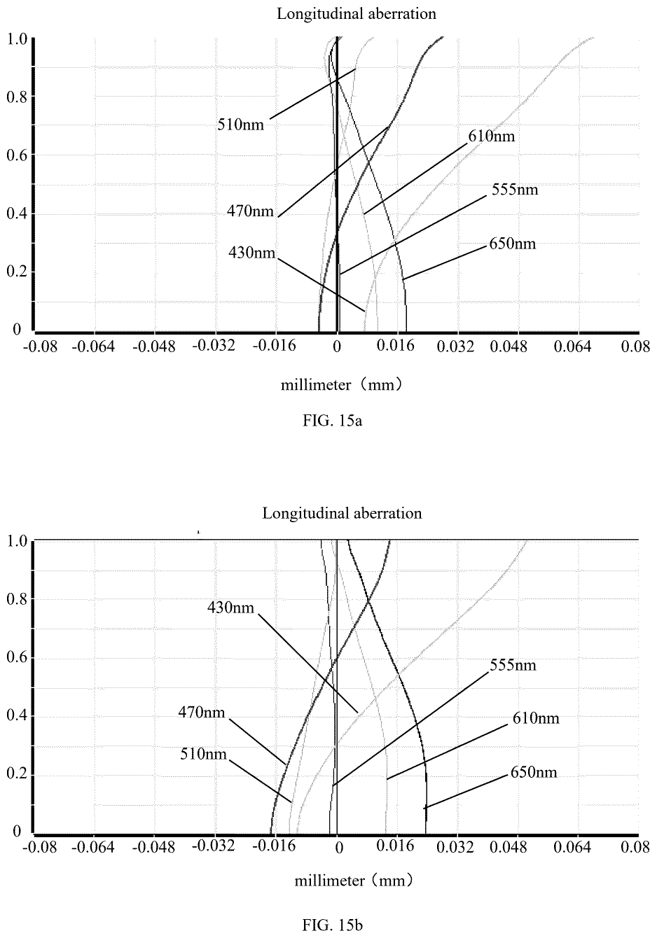

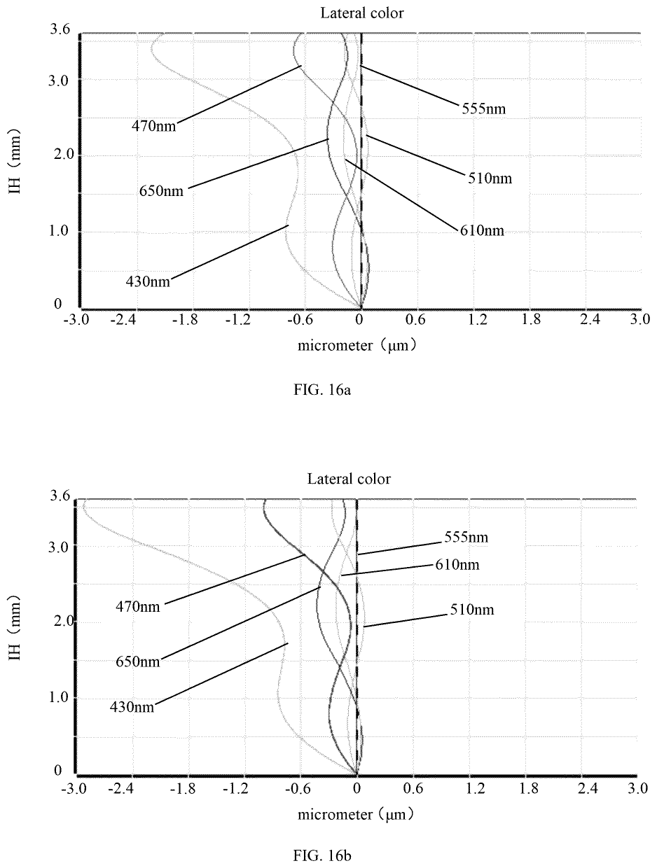

FIG. 14a and FIG. 14b show the field curvature and distortion schematic diagrams after light with a wavelength of 555 nm passes the camera optical lens 40 of the fourth embodiment. FIG. 15a and FIG. 15b show the longitudinal aberration schematic diagrams after light with a wavelength of 430 nm, 470 nm, 510 nm, 555 nm, 610 nm and 650 nm passes the camera optical lens 40 of the fourth embodiment. FIG. 16a and FIG. 16b show the lateral color schematic diagrams after light with a wavelength of 430 nm, 470 nm, 510 nm, 555 nm, 610 nm and 650 nm passes the camera optical lens 40 of the fourth embodiment.

As shown in Table 19, the fourth embodiment satisfies all conditional expressions.

In this embodiment, the entrance pupil diameter (ENPD) of the camera optical lens 40 in the first state is 7.197 mm, the full field image height (IH) is 3.600 mm, and the diagonal field of view (FOV) is 23.97°. The camera optical lens 40 satisfies the characteristics of large aperture, telephoto capability, and miniaturization, with both on-axis and off-axis chromatic aberrations fully corrected, while exhibiting excellent optical performance.

### Embodiment 5

The first prism P1 has a positive refractive power, with its object side surface convex in the paraxial region and its image side surface concave in the paraxial region;

The first lens L1 has a negative refractive power, with its object side surface concave in the paraxial region and its image side surface concave in the paraxial region;

The second lens L2 has a positive refractive power, with its object side surface convex in the paraxial region and its image side surface convex in the paraxial region;

The third lens L3 has a negative refractive power, with its object side surface concave in the paraxial region and its image side surface concave in the paraxial region;

The fourth lens L4 has a positive refractive power, with its object side surface convex in the paraxial region and its image side surface convex in the paraxial region;

The fifth lens L5 has a negative refractive power, with its object side surface concave in the paraxial region and its image side surface convex in the paraxial region.

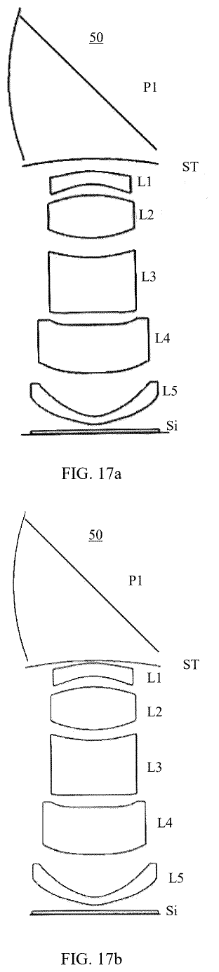

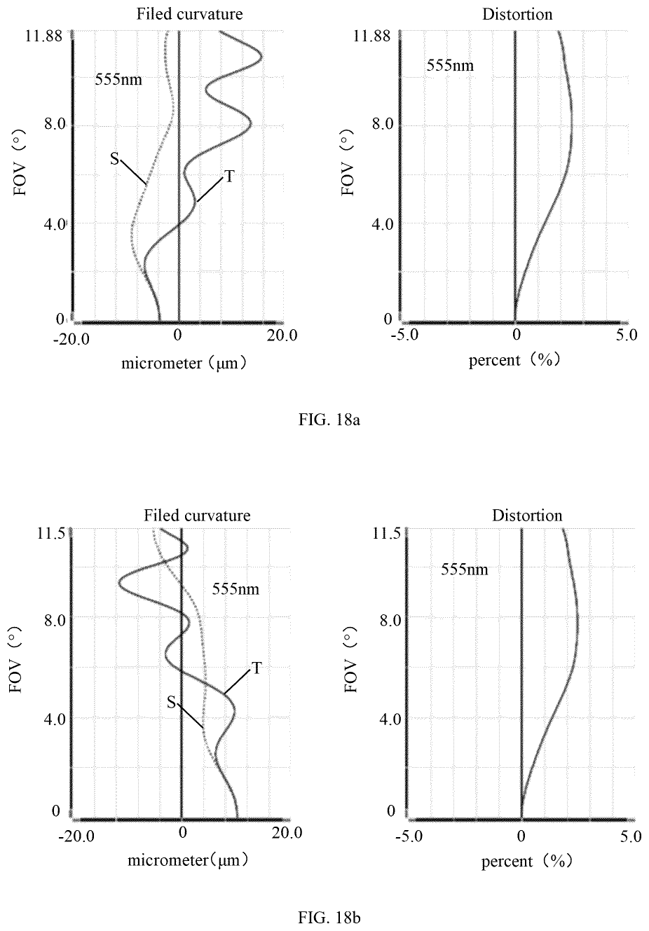

FIGS. 17a and 17b are schematic structural diagrams of the camera optical lens 50 in the fifth embodiment. The symbol meanings in the fifth embodiment are the same as those in the first embodiment.

Tables 13˜15 show the design data of the camera optical lens 50 in the fifth embodiment.

TABLE 13

| | R | d | | nd | | vd | |
|---|---|---|---|---|---|---|---|
| ST | ∞ | d0= | −9.666 | | | | |
| Rp1 | 13.401 | dp1= | 9.500 | nd1 | 1.8052 | vd1 | 40.89 |
| Rp2 | 22.335 | dp2= | dp2 | | | | |
| R1 | 5.665 | d1= | 0.803 | nd2 | 1.6400 | vd2 | 23.54 |
| R2 | 3.703 | d2= | 0.671 | | | | |
| R3 | 6.213 | d3= | 2.676 | nd3 | 1.5444 | vd3 | 55.82 |
| R4 | −6.459 | d4= | d4 | | | | |
| R5 | −7.166 | d5= | 3.424 | nd4 | 1.6153 | vd4 | 25.94 |
| R6 | 42.887 | d6= | 0.778 | | | | |
| R7 | 46.478 | d7= | 3.021 | nd5 | 1.6700 | vd5 | 19.39 |
| R8 | −17.449 | d8= | 2.709 | | | | |
| R9 | −1.897 | d9= | 0.500 | nd6 | 1.5346 | vd6 | 55.69 |
| R10 | −2.276 | d10= | 0.341 | | | | |
| R11 | ∞ | d11= | 0.210 | ndg | 1.5168 | vdg | 64.17 |
| R12 | ∞ | d12= | 0.030 | | | | |

In which, d1=“dp1-01”+“dp1-02”, “dp1-01”=4.9, and “dp1-02”=4.6.

Table 14 shows data of related optical parameters for the camera optical lens 50 according to the fifth embodiment of the present disclosure in a first state and a second state, respectively.

TABLE 14

| | First state | Second state |
|---|---|---|
| f | 16.782 | 15.593 |
| FOV | 23.77° | 23.10° |
| FNO | 2.32 | 2.56 |
| dp2 | 0.772 | 0.226 |
| d4 | 0.066 | 0.612 |

Table 15 shows the conic index and aspherical surface index of the camera optical lens 50.

TABLE 15

| | Conic | | | | | | | |
|---|---|---|---|---|---|---|---|---|
| | Index | Aspherical Surface Index | | | | | | |
| | K | A4 | A6 | A8 | A10 | A12 | A14 | A16 |
| Rp1 | −1.97748E+00 | 1.40450E−04 | 1.07270E−06 | −1.51180E−07 | 1.72980E−08 | −9.07280E−10 | 1.22390E−11 | 8.79650E−13 |
| Rp2 | 0.00000E+00 | 0.00000E+00 | 0.00000E+00 | 0.00000E+00 | 0.00000E+00 | 0.00000E+00 | 0.00000E+00 | 0.00000E+00 |
| R1 | −4.32599E+00 | −2.40020E−03 | −4.29180E−04 | 3.41270E−04 | −2.97250E−04 | 1.54200E−04 | −4.97170E−05 | 1.01590E−05 |
| R2 | −6.44101E−01 | −6.35720E−03 | −3.59300E−06 | −6.46990E−05 | −6.90790E−05 | 6.95610E−05 | −2.89770E−05 | 6.94460E−06 |
| R3 | −1.24164E+01 | 4.81630E−03 | −6.25000E−04 | −9.13840E−05 | 6.64770E−05 | −2.05640E−05 | 3.94520E−06 | −4.51090E−07 |
| R4 | 3.11690E−01 | −5.44250E−04 | 9.98360E−04 | −6.55190E−04 | 2.67390E−04 | −7.17200E−05 | 1.26330E−05 | −1.39710E−06 |
| R5 | −2.95805E+01 | −7.90920E−03 | 3.40710E−03 | −1.38280E−03 | 4.53930E−04 | −1.07590E−04 | 1.73350E−05 | −1.78940E−06 |
| R6 | 4.47168E+01 | −2.61990E−04 | −2.38660E−04 | −1.77570E−04 | 2.90410E−04 | −2.87780E−04 | 1.75410E−04 | −6.98140E−05 |
| R7 | −4.88470E−01 | −3.81110E−03 | −1.29070E−03 | 1.41800E−03 | −1.30690E−03 | 7.59620E−04 | −2.97820E−04 | 8.06250E−05 |
| R8 | 2.19657E+01 | −1.98960E−03 | −6.23150E−04 | 1.02050E−03 | −9.71780E−04 | 5.45180E−04 | −1.98510E−04 | 4.92290E−05 |
| R9 | −4.53721E+00 | −3.18090E−02 | 2.91130E−02 | −1.43160E−02 | 3.89390E−03 | −6.00050E−04 | 4.02880E−05 | 2.43830E−06 |
| R10 | −8.43563E+00 | −2.02920E−02 | 2.64670E−02 | −1.24870E−02 | 3.32060E−03 | −5.96410E−04 | 8.22680E−05 | −9.73670E−06 |

| | Conic | | | | | | |
|---|---|---|---|---|---|---|---|
| | Index | Aspherical Surface Index | | | | | |
| | K | A18 | A20 | A22 | A24 | A26 | A28 |
| Rp1 | −1.97748E+00 | −3.97700E−14 | 4.90470E−16 | 0.00000E+00 | 0.00000E+00 | 0.00000E+00 | 0.00000E+00 |
| Rp2 | 0.00000E+00 | 0.00000E+00 | 0.00000E+00 | 0.00000E+00 | 0.00000E+00 | 0.00000E+00 | 0.00000E+00 |
| R1 | −4.32599E+00 | −1.28160E−06 | 9.12200E−08 | −2.80844E−09 | 0.00000E+00 | 0.00000E+00 | 0.00000E+00 |
| R2 | −6.44101E−01 | −9.84690E−07 | 7.69810E−08 | −2.57224E−09 | 0.00000E+00 | 0.00000E+00 | 0.00000E+00 |
| R3 | −1.24164E+01 | 2.92900E−08 | −8.78610E−10 | 0.00000E+00 | 0.00000E+00 | 0.00000E+00 | 0.00000E+00 |
| R4 | 3.11690E−01 | 8.79910E−08 | −2.40950E−09 | 0.00000E+00 | 0.00000E+00 | 0.00000E+00 | 0.00000E+00 |
| R5 | −2.95805E+01 | 1.06200E−07 | −2.74590E−09 | 0.00000E+00 | 0.00000E+00 | 0.00000E+00 | 0.00000E+00 |
| R6 | 4.47168E+01 | 1.87420E−05 | −3.42560E−06 | 4.20645E−07 | −3.32267E−08 | 1.52610E−09 | −3.09906E−11 |
| R7 | −4.88470E−01 | −1.50970E−05 | 1.91440E−06 | −1.55309E−07 | 7.00965E−09 | −1.03750E−10 | −2.18928E−12 |
| R8 | 2.19657E+01 | −8.48300E−06 | 1.01640E−06 | −8.30770E−08 | 4.41821E−09 | −1.37790E−10 | 1.91181E−12 |
| R9 | −4.53721E+00 | −7.51680E−07 | 6.64300E−08 | −2.79086E−09 | 4.71227E−11 | 0.00000E+00 | 0.00000E+00 |
| R10 | −8.43563E+00 | 1.01150E−06 | −8.47470E−08 | 5.13199E−09 | −2.03777E−10 | 4.68814E−12 | −4.71352E−14 |

Additionally, in the subsequent Table 19, the values corresponding to various parameters defined in the conditional expressions for the fifth embodiment are listed.

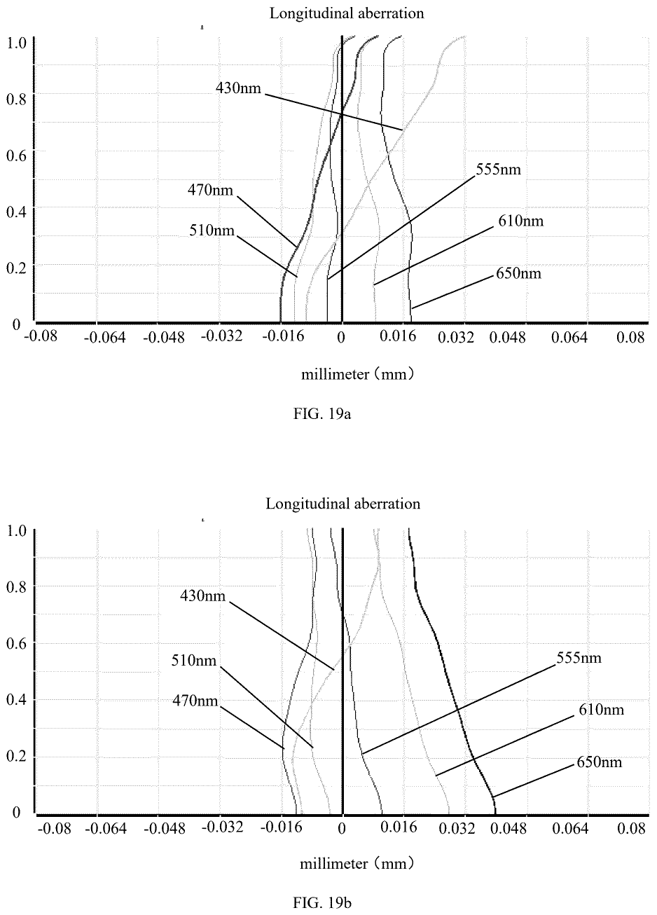

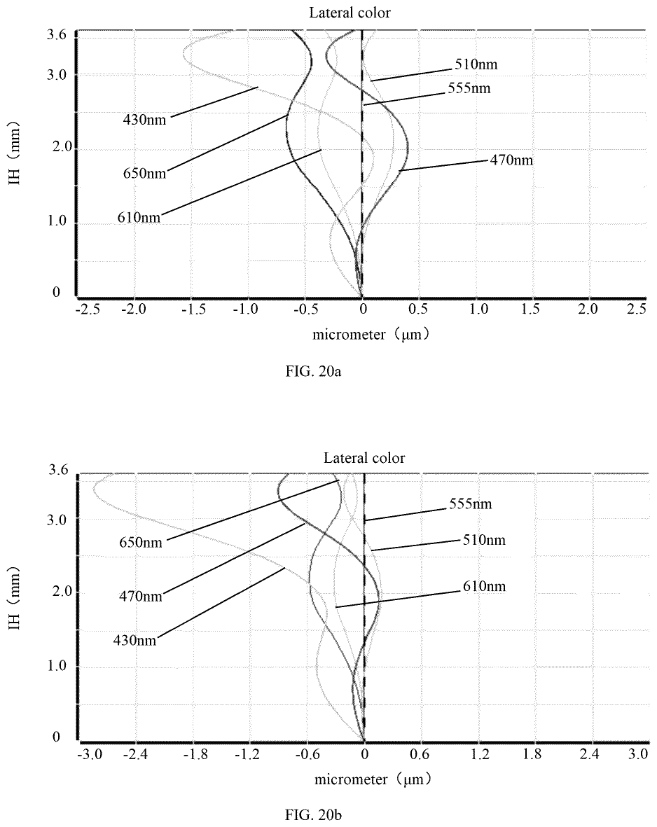

FIG. 18a and FIG. 18b show the field curvature and distortion schematic diagrams after light with a wavelength of 555 nm passes the camera optical lens 50 of the fifth embodiment. FIG. 19a and FIG. 19b show the longitudinal aberration schematic diagrams after light with a wavelength of 430 nm, 470 nm, 510 nm, 555 nm, 610 nm and 650 nm passes the camera optical lens 50 of the fifth embodiment. FIG. 20a and FIG. 20b show the lateral color schematic diagrams after light with a wavelength of 430 nm, 470 nm, 510 nm, 555 nm, 610 nm and 650 nm passes the camera optical lens 50 of the fifth embodiment.

As shown in Table 19, the fifth embodiment satisfies all conditional expressions.

In this embodiment, the entrance pupil diameter (ENPD) of the camera optical lens 50 in the first state is 6.726 mm, the full field image height (IH) is 3.6 mm, and the diagonal field of view (FOV) is 23.77°. The camera optical lens 50 satisfies the characteristics of large aperture, telephoto capability, and miniaturization, with both on-axis and off-axis chromatic aberrations fully corrected, while exhibiting excellent optical performance.

### Embodiment 6

The first prism P1 has a positive refractive power, with its object side surface convex in the paraxial region and its image side surface concave in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface convex in the paraxial region;

The third lens L3 has a negative refractive power, with its object side surface concave in the paraxial region and its image side surface concave in the paraxial region;

The fourth lens L4 has a positive refractive power, with its object side surface convex in the paraxial region and its image side surface convex in the paraxial region;

The fifth lens L5 has a negative refractive power, with its object side surface concave in the paraxial region and its image side surface convex in the paraxial region.

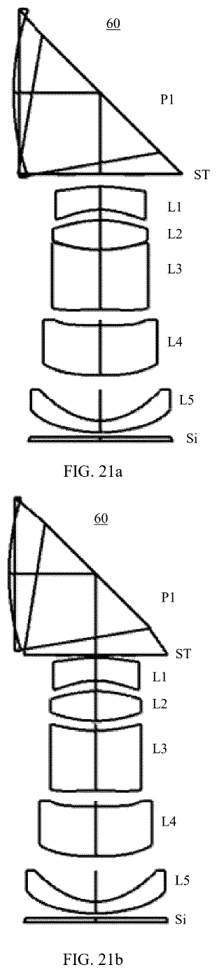

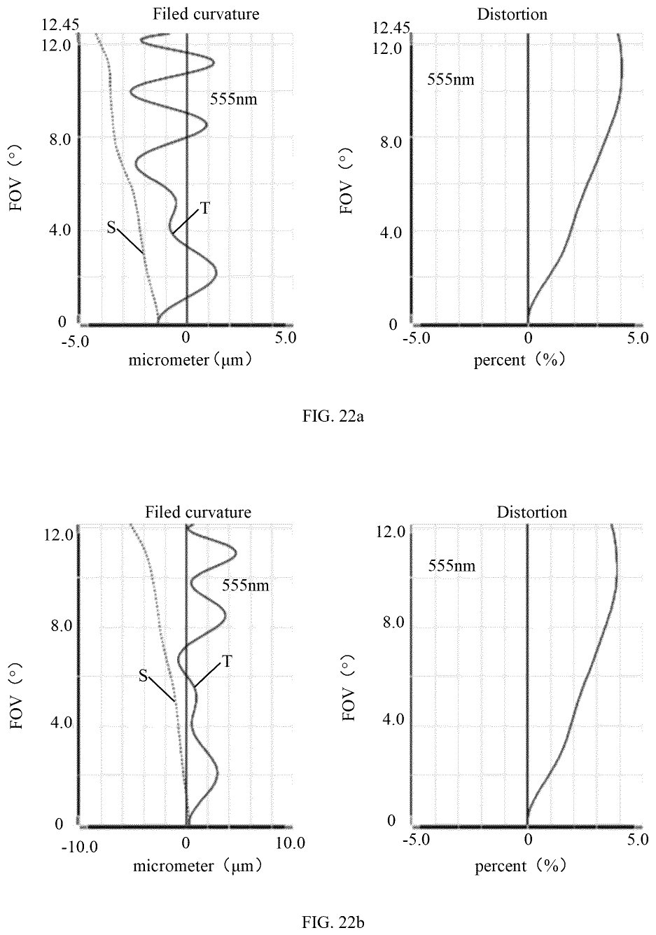

FIGS. 21a and 21b are schematic structural diagrams of the camera optical lens 60 in the sixth embodiment. The symbol meanings in the sixth embodiment are the same as those in the first embodiment.

Tables 16˜18 show the design data of the camera optical lens 60 in the sixth embodiment.

TABLE 16

| | R | d | | nd | | vd | |
|---|---|---|---|---|---|---|---|
| ST | ∞ | d0= | −9.550 | | | | |
| Rp1 | 14.686 | dp1= | 9.500 | nd1 | 1.8052 | vd1 | 40.89 |
| Rp2 | 146.863 | dp2= | dp2 | | | | |
| R1 | 7.363 | d1= | 1.309 | nd2 | 1.6400 | vd2 | 23.54 |
| R2 | 3.851 | d2= | 0.608 | | | | |
| R3 | 6.038 | d3= | 1.679 | nd3 | 1.5444 | vd3 | 55.82 |
| R4 | −6.896 | d4= | d4 | | | | |
| R5 | −7.068 | d5= | 3.412 | nd4 | 1.6153 | vd4 | 25.94 |
| R6 | 66.092 | d6= | 0.862 | | | | |
| R7 | 56.478 | d7= | 2.860 | nd5 | 1.6700 | vd5 | 19.39 |
| R8 | −17.026 | d8= | 2.576 | | | | |
| R9 | −3.084 | d9= | 0.671 | nd6 | 1.5346 | vd6 | 55.69 |
| R10 | −4.317 | d10= | 0.262 | | | | |
| R11 | ∞ | d11= | 0.210 | ndg | 1.5168 | vdg | 64.17 |
| R12 | ∞ | d12= | 0.030 | | | | |

In which, d1=“dp1-01”+“dp1-02”, “dp1-01”=4.9, and “dp1-02”=4.6.

Table 17 shows data of related optical parameters for the camera optical lens 60 according to the sixth embodiment of the present disclosure in a first state and a second state, respectively.

TABLE 17

| | First state | Second state |
|---|---|---|
| f | 15.693 | 14.401 |
| FOV | 24.90° | 24.32° |
| FNO | 2.32 | 2.58 |
| dp2 | 0.701 | 0.130 |
| d4 | 0.011 | 0.582 |

Table 18 shows the conic index and aspherical surface index of the camera optical lens 50.

TABLE 18

| | Conic | | | | | | | |
|---|---|---|---|---|---|---|---|---|
| | Index | Aspherical Surface Index | | | | | | |
| | K | A4 | A6 | A8 | A10 | A12 | A14 | A16 |
| Rp1 | −2.15794E+00 | 1.32100E−04 | −2.03260E−07 | 7.75840E−08 | −1.36860E−08 | 1.70750E−09 | −1.29650E−10 | 5.83090E−12 |
| Rp2 | 0.00000E+00 | 0.00000E+00 | 0.00000E+00 | 0.00000E+00 | 0.00000E+00 | 0.00000E+00 | 0.00000E+00 | 0.00000E+00 |
| R1 | −4.52572E+00 | −3.16470E−03 | −8.45270E−05 | 5.94920E−06 | −9.02500E−07 | 9.63480E−07 | −4.83630E−07 | 1.23510E−07 |
| R2 | −6.61747E−01 | −6.89800E−03 | −1.73470E−04 | 5.98960E−05 | −3.17400E−05 | 1.71390E−05 | −6.48370E−06 | 1.66420E−06 |
| R3 | −1.30390E+01 | 5.16200E−03 | −1.22070E−03 | 1.79650E−04 | −9.24220E−06 | −7.97150E−06 | 3.49910E−06 | −6.67340E−07 |
| R4 | 1.99241E−01 | 2.80280E−04 | −5.69150E−05 | 3.40460E−05 | −1.52010E−05 | 4.83060E−06 | −8.09280E−07 | 6.57140E−08 |
| R5 | −2.93093E+01 | −7.39680E−03 | 2.55200E−03 | −7.88700E−04 | 2.05700E−04 | −4.02370E−05 | 5.31670E−06 | −4.25310E−07 |
| R6 | 8.45864E+01 | −5.36800E−04 | −2.83240E−04 | −1.29460E−04 | 2.92760E−04 | −2.92950E−04 | 1.76450E−04 | −7.05710E−05 |
| R7 | −2.57156E+01 | −4.72490E−03 | −4.30250E−04 | 1.87660E−05 | 8.17280E−05 | −1.15820E−04 | 7.84620E−05 | −3.36150E−05 |
| R8 | 2.20973E+01 | −2.04660E−03 | −8.41150E−04 | 8.64700E−04 | −6.41550E−04 | 3.25370E−04 | −1.14170E−04 | 2.81330E−05 |
| R9 | −5.04375E+00 | 6.03450E−03 | −1.86800E−02 | 1.31320E−02 | −5.67890E−03 | 1.63820E−03 | −3.22510E−04 | 4.33830E−05 |
| R10 | −2.30885E+01 | 4.58000E−02 | −5.22130E−02 | 3.05590E−02 | −1.13980E−02 | 2.88680E−03 | −5.13050E−04 | 6.50640E−05 |

| | Conic | | | | | | |
|---|---|---|---|---|---|---|---|
| | Index | Aspherical Surface Index | | | | | |
| | K | A18 | A20 | A22 | A24 | A26 | A28 |
| Rp1 | −2.15794E+00 | −1.42590E−13 | 1.45770E−15 | 0.00000E+00 | 0.00000E+00 | 0.00000E+00 | 0.00000E+00 |
| Rp2 | 0.00000E+00 | 0.00000E+00 | 0.00000E+00 | 0.00000E+00 | 0.00000E+00 | 0.00000E+00 | 0.00000E+00 |
| R1 | −4.52572E+00 | −1.68440E−08 | 1.13080E−09 | −2.81353E−11 | 0.00000E+00 | 0.00000E+00 | 0.00000E+00 |
| R2 | −6.61747E−01 | −2.69940E−07 | 2.45020E−08 | 9.47093E−10 | 0.00000E+00 | 0.00000E+00 | 0.00000E+00 |
| R3 | −1.30390E+01 | 6.34110E−08 | −2.48370E−09 | 0.00000E+00 | 0.00000E+00 | 0.00000E+00 | 0.00000E+00 |
| R4 | 1.99241E−01 | −9.94770E−10 | −1.36290E−10 | 0.00000E+00 | 0.00000E+00 | 0.00000E+00 | 0.00000E+00 |
| R5 | −2.93093E+01 | 1.71910E−08 | −2.14070E−10 | 0.00000E+00 | 0.00000E+00 | 0.00000E+00 | 0.00000E+00 |
| R6 | 8.45864E+01 | 1.93830E−05 | −3.67570E−06 | 4.73068E−07 | −3.94453E−08 | 1.92144E−09 | −4.14944E−11 |
| R7 | −2.57156E+01 | 9.69930E−06 | −1.91210E−06 | 2.54209E−07 | −2.17952E−08 | 1.08782E−09 | −2.40084E−11 |
| R8 | 2.20973E+01 | 4.89660E−06 | 5.98290E−07 | −5.01681E−08 | 2.74753E−09 | −8.84676E−11 | 1.26957E−12 |
| R9 | −5.04375E+00 | −3.91550E−06 | 2.26470E−07 | −7.57713E−09 | 1.11411E−10 | 0.00000E+00 | 0.00000E+00 |
| R10 | −2.30885E+01 | −5.91800E−06 | 3.83450E−07 | −1.73044E−08 | 5.18199E−10 | −9.28690E−12 | 7.56887E−14 |

Additionally, in the subsequent Table 19, the values corresponding to various parameters defined in the conditional expressions for the sixth embodiment are listed.

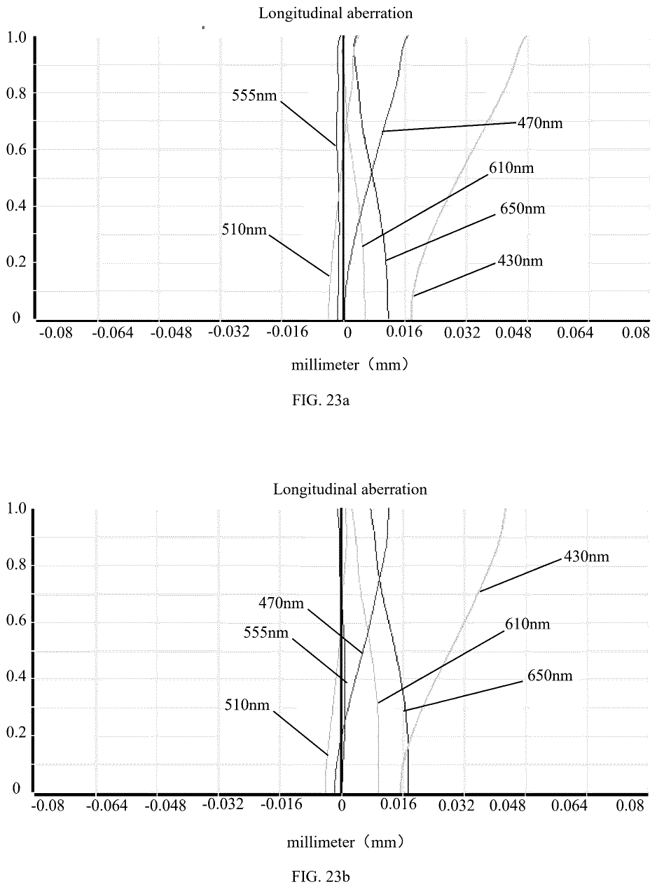

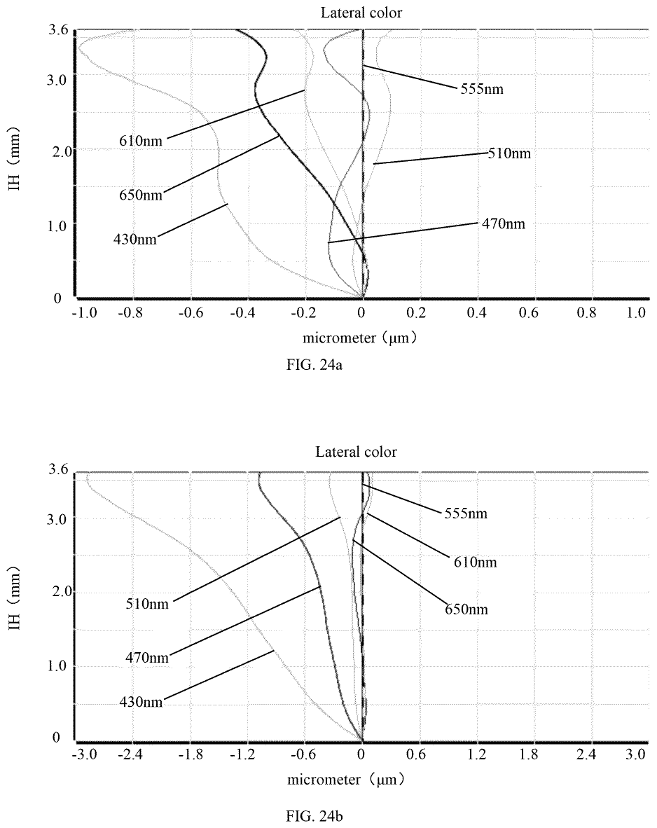

FIG. 22a and FIG. 22b show the field curvature and distortion schematic diagrams after light with a wavelength of 555 nm passes the camera optical lens 60 of the sixth embodiment. FIG. 23a and FIG. 23b show the longitudinal aberration schematic diagrams after light with a wavelength of 430 nm, 470 nm, 510 nm, 555 nm, 610 nm and 650 nm passes the camera optical lens 60 of the sixth embodiment. FIG. 24a and FIG. 24b show the lateral color schematic diagrams after light with a wavelength of 430 nm, 470 nm, 510 nm, 555 nm, 610 nm and 650 nm passes the camera optical lens 60 of the sixth embodiment.

As shown in Table 19, the sixth embodiment satisfies all conditional expressions.

In this embodiment, the entrance pupil diameter (ENPD) of the camera optical lens 60 in the first state is 6.774 mm, the full field image height (IH) is 3.600 mm, and the diagonal field of view (FOV) is 24.90°. The camera optical lens 60 satisfies the characteristics of large aperture, telephoto capability, and miniaturization, with both on-axis and off-axis chromatic aberrations fully corrected, while exhibiting excellent optical performance.

TABLE 19

| Parameters and | Embodi- | Embodi- | Embodi- |
|---|---|---|---|
| Conditional Expressions | ment 1 | ment 2 | ment 3 |
| fA/IH | 4.27 | 4.14 | 4.51 |
| Rp1/Rp2 | 1.00 | 0.70 | 0.70 |
| d5/d7 | 0.27 | 0.59 | 0.80 |
| d1/d3 | 0.74 | 0.90 | 0.75 |
| fA | 15.378 | 15.889 | 16.218 |
| fp1 | 57.376 | 35.054 | 34.398 |
| f1 | −27.203 | −23.119 | −23.084 |
| f2 | 5.579 | 5.859 | 5.950 |
| f3 | −8.629 | −9.548 | −11.525 |
| f4 | 25.059 | 22.312 | 21.165 |
| f5 | −160.488 | −35.004 | −14.952 |
| TTL | 25.500 | 25.500 | 25.499 |
| Parameters and | Embodi- | Embodi- | Embodi- |
| Conditional Expressions | ment 4 | ment 5 | ment 6 |
| fA/IH | 4.64 | 4.66 | 4.36 |
| Rp1/Rp2 | 0.39 | 0.60 | 0.10 |
| d5/d7 | 1.14 | 1.13 | 1.19 |
| d1/d3 | 1.00 | 0.30 | 0.80 |
| fA | 16.686 | 16.782 | 15.693 |
| fp1 | 24.123 | 28.075 | 19.548 |
| f1 | −17.914 | −19.750 | −14.663 |
| f2 | 6.038 | 6.266 | 6.178 |
| f3 | −9.797 | −9.658 | −10.126 |
| f4 | 19.504 | 19.126 | 19.655 |
| f5 | 1259.993 | −39.303 | −24.840 |
| TTL | 25.410 | 25.501 | 24.669 |

The camera optical lenses provided in the embodiments of the present disclosure have been described in detail above. Specific examples are used in this document to elaborate on the principles and embodiments of the disclosure, and the descriptions of these embodiments are intended solely to facilitate understanding of the inventive concept. Modifications and variations may occur in specific embodiments and application scopes. In summary, the content of this specification should not be construed as limitations to the present disclosure.

What is claimed is:

1. A camera optical lens comprising, in an order from an object side to an image side in sequence: a first prism with a positive refractive power, a first lens with a negative refractive power, a second lens with a positive refractive power, a third lens with a negative refractive power, a fourth lens with a positive refractive power, and a fifth lens; wherein a reflective surface is disposed between the object side surface and the image side surface of the first prism, the first lens and the second lens are defined as a first lens group, while the third lens, the fourth lens and the fifth lens are defined as a second lens group, the first lens group is adjustably movable along the optical axis of the camera optical lens to switch the camera optical lens between a first state and a second state, the camera optical lens achieves its maximum focal length in the first state, and achieves its minimum focal length in the second state; and the camera optical lens further satisfies the following conditions:
$$4. \leq fA / IH \leq 4.8 ;$$
$$10 \leq Rp 1 / Rp 2 \leq 1. ;$$
$$0.2 \leq d 5 / d 7 \leq 1.2 ;$$
where
fA: the focal length of the camera optical lens in the first state;
IH: the image height of the camera optical lens;
Rp1: the curvature radius of the object side surface of the first prism;
Rp2: the curvature radius of the image side surface of the first prism;
d5: the thickness on-axis of the third lens;
d7: the thickness on-axis of the fourth lens.

2. The camera optical lens as described in claim 1 further satisfies the following condition:
$$4.1 \leq fA / IH \leq 4.70 .$$

3. The camera optical lens as described in claim 1, wherein an object side surface of the first prism is convex in the paraxial region, an image side surface of the first prism is concave in the paraxial region, and the camera optical lens further satisfies the following conditions:
$$1.24 \leq fp 1 / fA \leq 3.74 ;$$
$$0.37 \leq dp 1 / TTL \leq 0 \text{.39} ;$$
where
fp1: the focal length of the first prism;
dp1: the sum of the distance on-axis from the object side surface of the first prism to the reflective surface, and the distance on-axis from the reflective surface to the image side surface of the first prism;
TTL: the total optical length of the camera optical lens.

4. The camera optical lens as described in claim 1, wherein an image side surface of the first lens is concave in the paraxial region, and the camera optical lens further satisfies the following conditions:
$$- 1.77 \leq f l / fA \leq - 0 \text{.93} ;$$
$$0.2 \leq ( R 1 + R 2 ) / ( R 1 - R 2 ) \leq 5 \text{.82} ;$$
$$0.03 \leq d 1 / TTL \leq 0 \text{.06} ;$$
where
f1: the focal length of the first lens;
R1: the curvature radius of the object side surface of the first lens;
R2: the curvature radius of the image side surface of the first lens;
d1: the thickness on-axis of the first lens;
TTL: the total optical length of the camera optical lens.

5. The camera optical lens as described in claim 1, wherein an object side surface of the second lens is convex in the paraxial region, an image side surface of the second lens is convex in the paraxial region, and the camera optical lens further satisfies the following conditions:
$$0.36 \leq f 2 / fA \leq 0.4 ;$$
$$- 0.07 \leq ( R 3 + R 4 ) / ( R 3 - R 4 ) \leq 0.04 ;$$
$$0.05 \leq d 3 / TTL \leq 0 \text{.11} ;$$
where
f2: the focal length of the second lens;
R3: the curvature radius of the object side surface of the second lens;
R4: the curvature radius of the image side surface of the second lens;
TTL: the total optical length of the camera optical lens.

6. The camera optical lens as described in claim 1 further satisfies the following condition:
$$0.3 \leq d 1 / d 3 \leq 1. ;$$
where
d1: the thickness on-axis of the first lens;
d3: the thickness on-axis of the second lens.

7. The camera optical lens as described in claim 1, wherein an object side surface of the third lens is concave in the paraxial region, and the camera optical lens further satisfies the following conditions:
$$- 0.7 \; 2 \leq f 3 / fA \leq - 0 \text{.56} ;$$
$$- 1.27 \leq ( R 5 + R 6 ) / ( R 5 - R 6 ) \leq - 0.7 ;$$
$$0.04 \leq d 5 / TTL \leq 0 \text{.15} ;$$
where
f3: the focal length of the third lens;
R5: the curvature radius of the object side surface of the third lens;
R6: the curvature radius of the image side surface of the third lens;
TTL: the total optical length of the camera optical lens.

8. The camera optical lens as described in claim 1, wherein an object side surface of the fourth lens is convex in the paraxial region, an image side surface of the fourth lens is convex in the paraxial region, and the camera optical lens further satisfies the following conditions:
$$1.13 \leq f 4 / fA \leq 1.63 ;$$
$$- 0.7 \leq ( R 7 + R 8 ) / ( R 7 - R 8 ) \leq 0 \text{.74} ;$$
$$0.11 \leq d 7 / TTL \leq 0 \text{.16} ;$$
where
f4: the focal length of the fourth lens;
R7: the curvature radius of the object side surface of the fourth lens;
R8: the curvature radius of the image side surface of the fourth lens;
TTL: the total optical length of the camera optical lens.

9. The camera optical lens as described in claim 1 further satisfies the following conditions:
$$- 10. 45 \leq f 5 / fA \leq 75 \text{.52} ;$$
$$- 19. 08 \leq ( R 9 + R 10 ) / ( R 9 - R 10 ) \leq 15 \text{.96} ;$$
$$d 9 / TTL \leq 0 \text{.03} ;$$
where
f5: the focal length of the fifth lens;
R9: the curvature radius of the object side surface of the fifth lens;
R10: the curvature radius of the image side surface of the fifth lens;
d9: the thickness on-axis of the fifth lens;
TTL: the total optical length of the camera optical lens.

10. The camera optical lens as described in claim 1, wherein the first prism is made of glass material.
